(19) United States
(12) Patent Application Publication
(10) Pub. No.: US 2025/0203610 A1
(43) Pub. Date: Jun. 19, 2025

(54) UPLINK CONTROL INFORMATION MESSAGE MULTIPLEXING ON PHYSICAL UPLINK SHARED CHANNEL RESOURCES ACROSS DIFFERENT TRANSMISSION RECEPTION POINTS

(71) Applicant: QUALCOMM Incorporated, San Diego, CA (US)

(72) Inventors: Shaozhen Guo, Beijing (CN); Mostafa Khoshnevisan, San Diego, CA (US); Jing Sun, San Diego, CA (US); Xiaoxia Zhang, San Diego, CA (US); Tao Luo, San Diego, CA (US); Peter Gaal, San Diego, CA (US); Yan Zhou, San Diego, CA (US); Fang Yuan, Beijing (CN); Yi Huang, San Diego, CA (US)

(21) Appl. No.: 18/847,861

(22) PCT Filed: May 11, 2022
(86) PCT No.: PCT/CN2022/092174

§ 371 Date: Sep. 17, 2024

(51) Int. Cl. H04W 72/1268; H04W 72/0446

(52) U.S. Cl. CPC H04W 72/1268; H04W 72/0446

(57) ABSTRACT

This disclosure provides systems, methods, and devices for wireless communication that support uplink control information (UCI) message multiplexing onto physical uplink shared channel (PUSCH) resources across different transmission reception points (TRPs). In a first aspect, a method of wireless communication includes determining that a first physical uplink control channel (PUCCH) resource including one or more first UCI messages associated with a first control resource set (CORESET) pool index value overlaps in the time domain with a second PUCCH resource including one or more second UCI messages associated with a second CORESET pool index value. The UE may identify one or more PUSCH resources that overlap with at least one of the PUCCH resources. The UE multiplexes one or more of the UCI messages onto one or more of the PUSCH resources and transmits those PUSCH resources including the UCI messages. Other aspects and features are also claimed and described.

### TECHNICAL FIELD

Aspects of the present disclosure relate generally to wireless communication systems, and more particularly, to serving cells configured with multiple downlink control information (DCI) based multiple transmission reception points (TRPs). Some features may enable and provide improved communications, including uplink control information (UCI) message multiplexing onto physical uplink shared channel (PUSCH) resources across different TRPs in the serving cell.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes determining, by the UE, that a first physical uplink control channel (PUCCH) resource including one or more first uplink control information (UCI) messages associated with a first control resource set (CORESET) pool index value overlaps in a time domain with a second PUCCH resource including one or more second UCI messages associated with a second CORESET pool index value, identifying, by the UE, one or more physical uplink shared channel (PUSCH) resources that overlaps in the time domain with at least one of the first PUCCH resource or the second PUCCH resource, multiplexing, by the UE, one or more of the one or more first UCI messages and the one or more second UCI messages onto one or more of the one or more PUSCH resources, and transmitting, by the UE, the one or more PUSCH resources on an associated component carrier after the multiplexing.

In an additional aspect of the disclosure, an apparatus configured for wireless communication is disclosed. The apparatus includes at least one processor, and a memory coupled to the at least one processor. The at least one processor is configured to determine, by the UE, that a first PUCCH resource including one or more first UCI messages associated with a first CORESET pool index value overlaps in a time domain with a second PUCCH resource including one or more second UCI messages associated with a second CORESET pool index value, to identify, by the UE, one or more PUSCH resources that overlaps in the time domain with at least one of the first PUCCH resource or the second PUCCH resource, to multiplex, by the UE, one or more of the one or more first UCI messages and the one or more second UCI messages onto one or more of the one or more PUSCH resources, and to transmit, by the UE, the one or more PUSCH resources on an associated component carrier after the multiplexing.

In an additional aspect of the disclosure, an apparatus configured for wireless communication is disclosed. The apparatus includes means for determining, by the UE, that a first PUCCH resource including one or more first UCI messages associated with a first CORESET pool index value overlaps in a time domain with a second PUCCH resource including one or more second UCI messages associated with a second CORESET pool index value, means for identifying, by the UE, one or more PUSCH resources that overlaps in the time domain with at least one of the first PUCCH resource or the second PUCCH resource, means for multiplexing, by the UE, one or more of the one or more first UCI messages and the one or more second UCI messages onto one or more of the one or more PUSCH resources, and means for transmitting, by the UE, the one or more PUSCH resources on an associated component carrier after execution of the means for multiplexing.

In an additional aspect of the disclosure, a non-transitory computer-readable medium stores instructions that, when executed by a processor, cause the processor to perform operations including determining, by the UE, that a first PUCCH resource including one or more first UCI messages associated with a first CORESET pool index value overlaps in a time domain with a second PUCCH resource including one or more second UCI messages associated with a second CORESET pool index value, identifying, by the UE, one or more PUSCH resources that overlaps in the time domain with at least one of the first PUCCH resource or the second PUCCH resource, multiplexing, by the UE, one or more of the one or more first UCI messages and the one or more second UCI messages onto one or more of the one or more PUSCH resources, and transmitting, by the UE, the one or more PUSCH resources on an associated component carrier after execution of the means for multiplexing.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating a serving cell 30 served by transmission reception points (TRPs) and having at least one CC/BWP configured with multiple CORESET pool index values.

FIG. 4 is a flow diagram illustrating an example process that supports UCI message multiplexing onto PUSCH resources across different TRPs according to one or more aspects.

FIGS. 5A-5B are block diagrams illustrating a UE configured for UCI message multiplexing onto PUSCH resources across different TRPs according to aspects of the present disclosure.

FIGS. 6A-6B are block diagrams illustrating a UE configured for UCI message multiplexing onto PUSCH resources across different TRPs according to aspects of the present disclosure.

FIGS. 7A-7B are block diagrams illustrating a UE configured for UCI message multiplexing onto PUSCH resources across different TRPs according to aspects of the present disclosure.

FIGS. 8A-8B are block diagrams illustrating a UE configured for UCI message multiplexing onto PUSCH resources across different TRPs according to aspects of the present disclosure.

FIG. 9 is a block diagram illustrating a UE configured for UCI message multiplexing onto PUSCH resources across different TRPs according to aspects of the present disclosure.

FIGS. 10A-10B are block diagrams illustrating a UE configured for UCI message multiplexing onto PUSCH resources across different TRPs according to aspects of the present disclosure.

FIG. 11 is a block diagram of an example UE that supports UCI message multiplexing onto PUSCH resources across different TRPs according to various aspects of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support uplink control information (UCI) message multiplexing onto physical uplink shared channel (PUSCH) resources across different transmission reception points (TRPs). Particular implementations of the subject matter described in this disclosure may be implemented to realize one or more of the following potential advantages or benefits. In some aspects, the present disclosure provides techniques for UCI message multiplexing onto PUSCH resources across different base stations allows for higher priority UCI messages to be transmitted while preserving PUSCH transmissions that may overlap scheduled PUCCH resource transmissions in the time domain.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.99999% reliability), ultra-low latency (e.g., ˜1 millisecond (ms)), and users with wide ranges of mobility or lack thereof, and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “mmW” band.

The frequencies between FR1 and FR2 are often referred to as mid-band frequencies. Recent 5G NR studies have identified an operating band for these mid-band frequencies as frequency range designation FR3 (7.126 GHz-24.25 GHz). Frequency bands falling within FR3 may inherit FR1 characteristics and/or FR2 characteristics, and, thus, may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2x (52.6 GHz-71 GHz), FR4 (71 GHz-114.25 GHz), and FR5 (114.25 GHz-275 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmW” or the like if used herein may broadly represent frequencies that may include mid-band frequencies, may be within FR2, FR2x, FR4, and/or FR5, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmW transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmW components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5GNR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

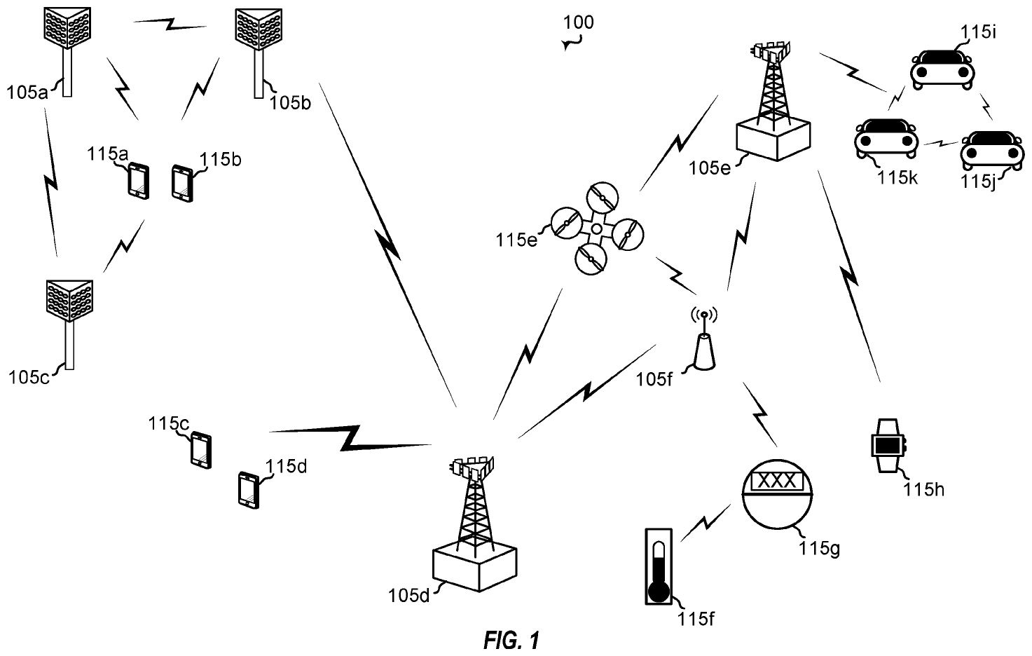

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 5G NR operations a transmission-reception point (TRP) may include various types of base stations 105, relays, or other types of networks entities providing a communication link with a UE, such as UEs 115. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

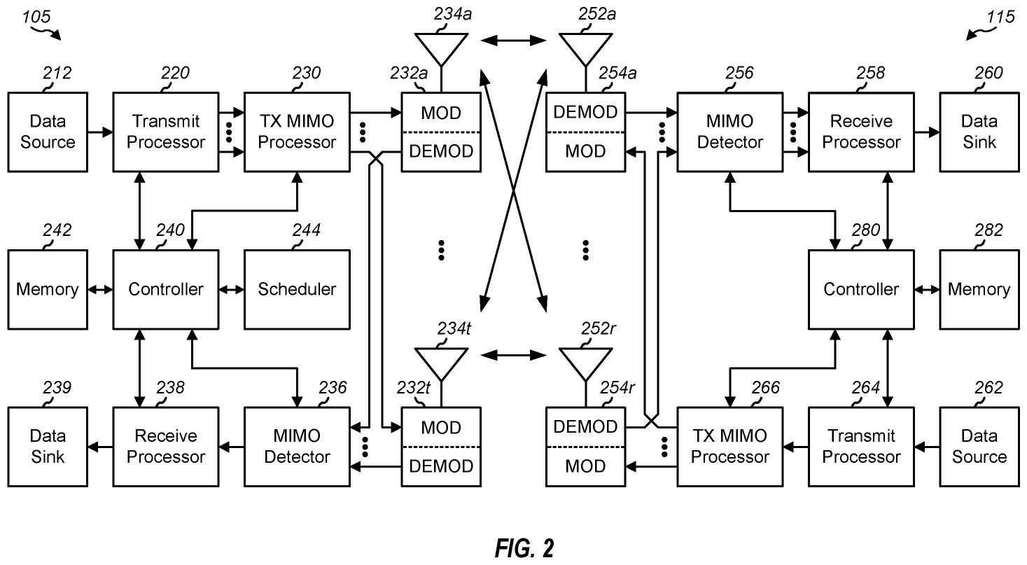

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

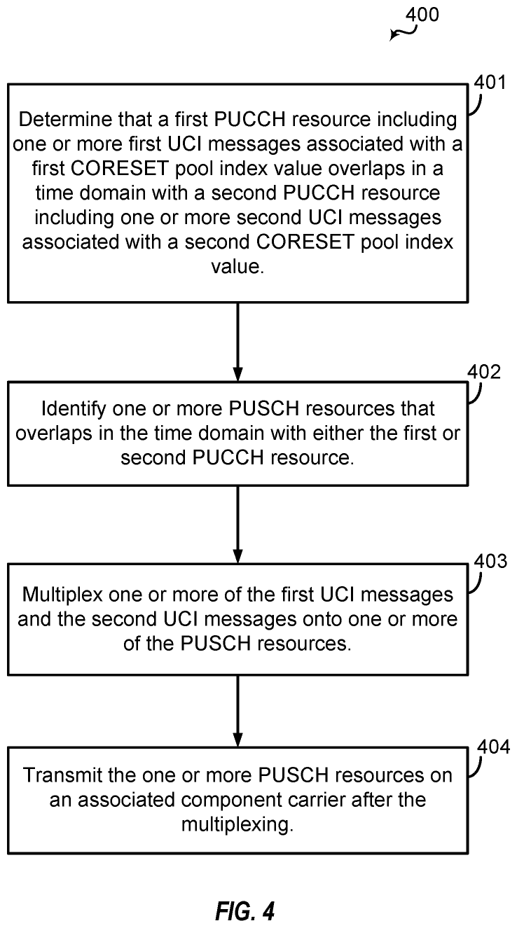

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 4, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

A physical uplink control channel (PUCCH) resource that includes acknowledgement information (e.g., hybrid automatic receipt request (HARQ) acknowledgement (ACK)/negative acknowledgement (NACK) information) or channel state information (CSI) may sometimes overlap in the time domain with a physical uplink shared channel (PUSCH) resource. 3GPP Release 15 (Rel. 15) and Release 16 (Rel. 16) new radio (NR) standards provide that the uplink control information (UCI) message (e.g., the acknowledgement information, CSI, etc.) may be multiplexed on the PUSCH resource. In such functionality, a UE would first resolve any overlapping different PUCCH resources in order to perform UCI multiplexing. For example, the UE may determine that a first PUCCH resource that includes HARQ-ACK/NACK overlaps in time with a second PUCCH resource that includes CSI or, perhaps, a scheduling request. The UE would multiplex the HARQ-ACK/NACK, CSI or SR onto a single PUCCH resource. This process results in a non-overlapping PUCCH resource including multiple UCI messages (e.g., HARQ-ACK/NACK/CSI/SR).

The UE may then multiplex the one or more UCI messages of the non-overlapping PUCCH resource onto a PUSCH resource when the corresponding PUCCH resource overlaps in the time domain with the PUSCH resource. In such case, the PUCCH resource will not be transmitted by the UE. The overlapping PUCCH and PUSCH in this process may reside in the same component carrier (CC) or different CCs.

It should be noted that, when a dynamically scheduled channel, such as one scheduled by a downlink control information (DCI) message, is involved, the UE would satisfy any joint timelines for UCI multiplexing on either the PUCCH resource or the PUSCH resource.

The multiplexing procedure may be facilitated using a beta offset signaled to the UE in an uplink grant (e.g., DCI 0_1/0_2), radio resource control (RRC) signaling, or the like. The beta offset may be used to control the rate matching behavior, such as identifying the number of resources that a UCI payload can occupy on the PUSCH resource.

Support for simultaneous transmission of PUCCH/PUSCH resources has been introduced in 3GPP Release 17 (Rel. 17). However, such simultaneous transmission is provided for when the PUCCH and PUSCH resources are on different cells in inter-band carrier aggregation (CA), in which the PUCCH/PUSCH resources are associated with different physical (PHY) layer priority (e.g., one of the PUCCH/PUSCH resource is high-priority while the other PUSCH/PUCCH resource is low-priority). Simultaneous PUCCH/PUSCH transmission is currently not supported for PUCCH/PUSCH resources on the same cell, nor on CCs in intra-band CA, nor on CCs in inter-band CA while the PUCCH/PUSCH resources have the same PHY layer priority. A PUSCH resource that can be simultaneously transmitted with a PUCCH resource may be excluded from overlapping channels for the rules on UCI multiplexing or prioritization and may not be constrained by intra-UE multiplexing timeline constraints.

5G NR operations may provide a plurality of serving cells, in which each serving cell may be configured having multiple bandwidth parts (BWPs) for serving a UE within the associated serving cell and in which each serving cell may be served by multiple base stations, such that each CC or BWP may be configured with multiple control resource sets (CORESETs) and each CORESET is associated with a CORESET pool index. When such UE receives a downlink control information (DCI) message and downlink transmissions from multiple transmission reception points (TRPs) within the serving cell, multiple timing advances may be defined for uplink transmissions from the UE. The DCI message may be received in a CORESET associated with a given CORESET pool index value so that the UE can identify the DCI that is associated with which TRP.

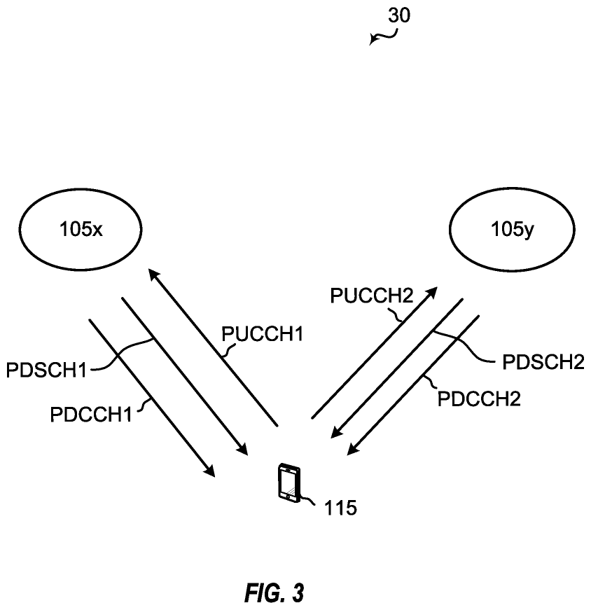

FIG. 3 is a block diagram illustrating a serving cell 30 served by TRPs 105x and 105y and having at least one CC/BWP configured with multiple CORESET pool index values. Serving cell 30 is configured for UE 115 to maintain communication with multiple TRPs, such as TRPs 105x and 105y. In one implementation, UE 115 may maintain such multi-TRP communications using a multi-DCI message based design. For example, TRP 105x may transmit a first DCI within PDCCH1, which schedules the downlink transmission, PDSCH1, from TRP 105x. TRP 105y may transmit a second DCI within PDCCH2, which schedules the downlink transmission, PDSCH2, from TRP 105y.

On the UE side, UE 115 may be configured via upper layer signalling with multiple CORESETs for the active BWP of a serving cell, such as serving cell 30. UE 115 may then differentiate which of TRP 105x or 105y is transmitting based on the CORESET pool index value associated with the CORESET in which the DCI message is received. Each CORESET (currently up to a maximum of 5 CORESETs) can be configured with a CORESET pool index value. Current standards provide that the CORESET pool index value may be 0 or 1. This configuration groups the CORESETs into two groups. Other than the different CORESETs, the number of TRPs serving the serving cell is transparent to UE 115. The CORESET pool index of the CORESET in which a DCI is received may be used for different purposes such as for HARQ-ACK/NACK feedback, CSI, SR, or the like.

Rel. 16 has also defined two acknowledgement feedback modes for such operations. In a separate acknowledgement feedback mode, UE 115 would provide any ACK or NACK feedback in PUCCH1 and PUCCH2 to TRPs 105x and 105y, respectively. In a joint acknowledgement feedback mode, UE 115 may include the ACK/NACK for each of downlink transmissions, PDSCH1 and PDSCH2, within a single PUCCH, such as PUCCH1.

Support for simultaneous PUCCH transmission over one CC may be specified in 3GPP Release 18 (Rel. 18) for the multi-DCI, multi-TRP operation. One proposed implementation for such simultaneous PUCCH transmission in one CC provides for simultaneous PUCCH transmission for separate feedback. Simultaneous PUCCH/PUSCH transmission, however, is not in scope of Rel. 18. For the case of multi-DCI based multi-TRP operation, either multiple PUSCH resources may be simultaneously transmitted across two antenna panels in the same CC or multiple PUCCH resources can be simultaneously transmitted across two antenna panels in the same CC.

For example, assuming a first PUCCH resource and a second PUCCH resource are determined to be overlapping in the time domain, such that the first and second PUCCH resources can be simultaneously transmitted, the first PUCCH resource in this example includes a first UCI message of a HARQ-ACK/NACK associated with CORESET pool index 0, and the second PUCCH resource includes a second UCI message of HARQ-ACK/NACK associated with CORESET pool index 1. In the described example, a PUSCH resource overlaps with both the first and second PUCCH resources and is associated with CORESET pool index 0. If the first UCI message is multiplexed onto the PUSCH resource associated with the same CORESET pool index value 0, then the second UCI message would be dropped because simultaneous PUCCH/PUSCH resource transmission is not supported, except in the limited circumstances described above from Rel. 17. However, HARQ-ACK/NACK has a higher priority than PUSCH.

Solutions for the UE behavior have been suggested that assume the UCI message can be multiplexed on a PUSCH resource associated with the same CORESET pool index. In such suggested case, the UE may determine which of first and second UCI messages are multiplexed with which one of the PUSCH resources and which resource between the PUCCH resources and PUSCH resources should be dropped after multiplexing. However, for ideal backhaul implementations, it may be possible to multiplex UCI messages on any of the PUSCH resources regardless of the associated CORESET pool index values. In such ideal backhaul implementations, different UE behaviors may be considered, such as, whether the UE can multiplex both first and second UCI message on the PUSCH resource. The various aspects of the present disclosure provide for UE behaviors when one or more of two time domain overlapping PUCCH resources, that can be simultaneously transmitted, overlap with one or more PUSCH resources.

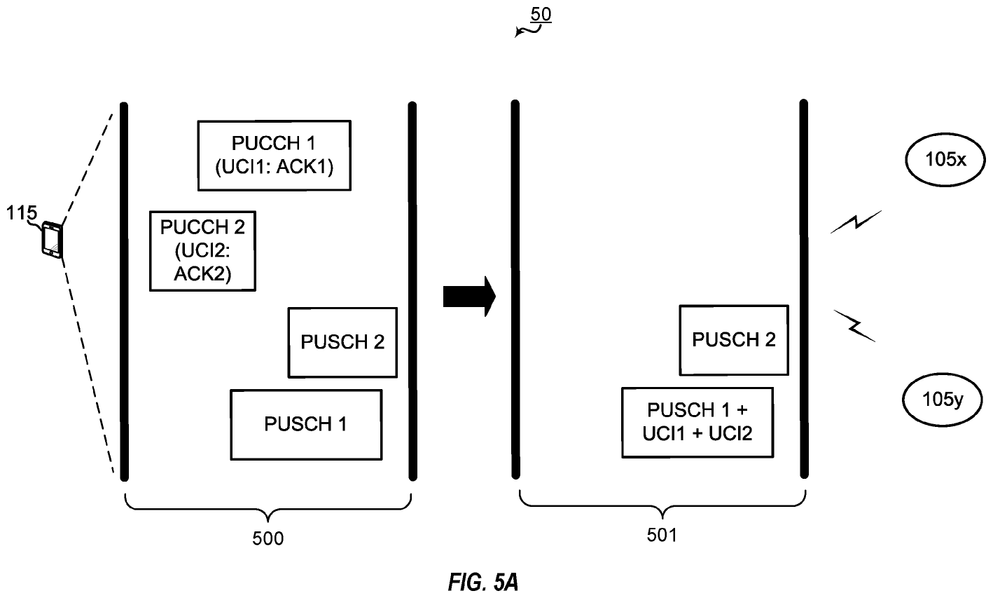

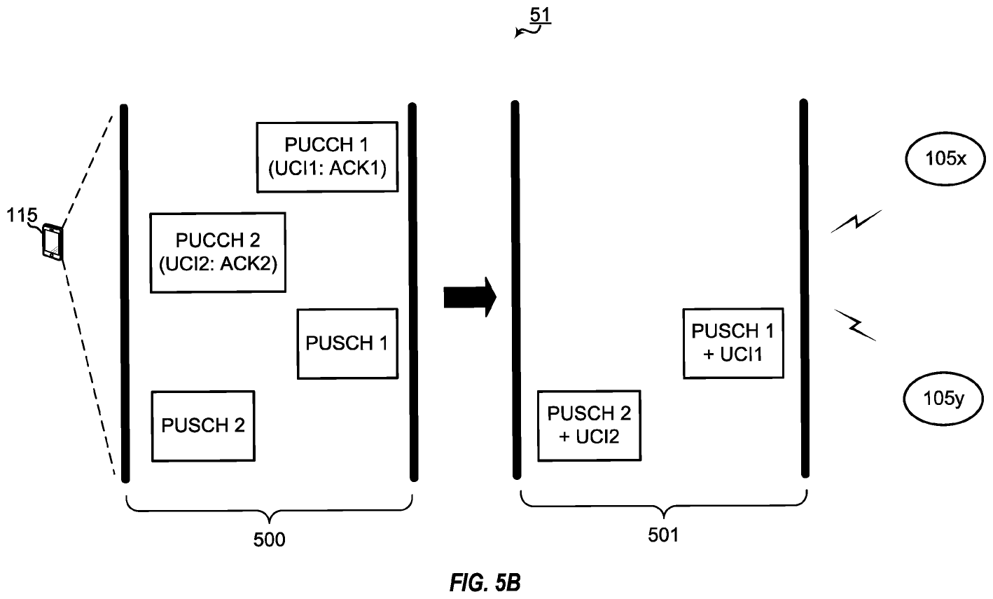

FIG. 4 is a flow diagram illustrating an example process 400 that supports UCI message multiplexing onto PUSCH resources across different TRPs according to one or more aspects. Operations of process 400 may be performed by a UE, such as UE 115 described above with reference to FIGS. 1, 2, 3, or a UE described with reference to FIG. 5. For example, example operations (also referred to as “blocks”) of process 400 may enable UE 115 to support UCI message multiplexing onto PUSCH resources across different TRPs.

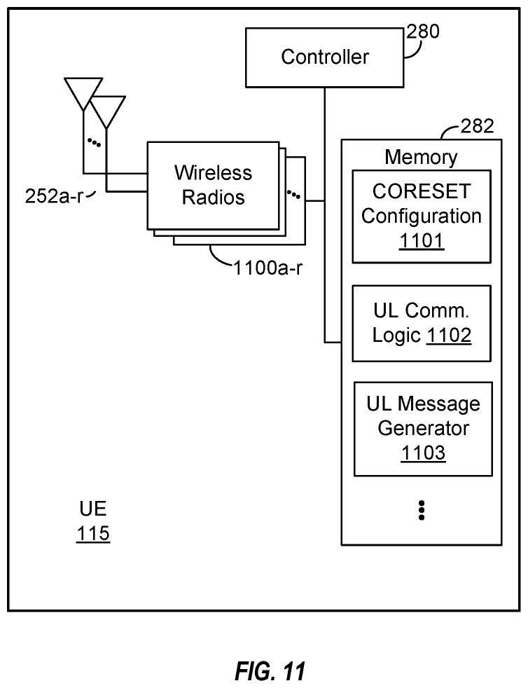

Process 400 may be described with respect to FIG. 11. FIG. 11 is a block diagram of an example UE 115 that supports UCI message multiplexing onto PUSCH resources across different base stations according to various aspects of the present disclosure. UE 115 may be configured to perform operations, including the blocks of a process described with reference to FIG. 4. In some implementations, UE 115 includes the structure, hardware, and components shown and described with reference to UE 115 of FIGS. 1-2. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 1100a-r and antennas 252a-r. Wireless radios 1100a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include CORESET configuration 1101, uplink (UL) communication logic 1102, and uplink message generator 1103. CORESET configuration 1101 may be configured to maintain the CORESETs configured for UE 115, which may be indexed via the CORESET pool index value. Uplink communication logic 1102 may be configured to manage uplink communications from UE 115, including determination of the schedules for PUCCH and PUSCH. Uplink message generator 1103 may be configured to generate the uplink communications, including UCI messages, data transmissions, and the like. UE 115 may receive signals from or transmit signals via antennas 252a-r and wireless radios 1100a-r to one or more network entities, such as base stations or TRPs 105 of FIGS. 1-3 and 5A-10B.

At block 401, a UE determines that a first PUCCH resource including one or more first UCI messages associated with a first CORESET pool index value overlaps in a time domain with a second PUCCH resource including one or more second UCI messages associated with a second CORESET pool index value. A UE, such as UE 115, may be configured for communications with multiple TRPs and will receive configuration information with regard to multiple CORESETS. The CORESETs, which are identified according to a CORESET pool index value in a DCI message, are stored in memory 282 at CORESET configuration 1101. UE 115 may further execute, under control of controller 280, uplink communication logic 1102. Controller 280 executes the code of uplink communication logic 1102, referred to as the “execution environment” of uplink communication logic 1102, to provide UE 115 with the features and functionality for managing uplink communications. This functionality may include scheduling of PUCCH and PUSCH resource transmissions, determining and planning UCI messages, and the like.

Within the execution environment of uplink communication logic 1102, UE 115 may determine two time domain overlapping PUCCH resources that can be simultaneously transmitted in a first CC (e.g., primary cell (PCell), PUCCH-secondary cell (PSCell), etc.), where the first PUCCH resource may include one or more UCI messages associated with a first CORESET pool index value. The UCI messages may be HARQ-ACK/NACK, CSI, SR, or a combination of such UCI types (e.g., HARQ-ACK/NACK+CSI or HARQ-ACK/NACK+SR or HARQ-ACK/NACK+SR+CSI). The second PUCCH resource may also include one or more UCIs associated with a second, different CORESET pool index value. The UCI messages of the second PUCCH may also be HARQ-ACK/NACK, CSI, SR, or a combination thereof. The first and second PUCCH resources are determined after the procedures are determined for UCI multiplexing of overlapping PUCCHs.

At block 402, the UE identifies one or more PUSCH resources that overlaps in the time domain with at least one of the first PUCCH resource or the second PUCCH resource. Within the execution environment of uplink communication logic 1102, UE 115 may determine whether the one or more PUSCH resources overlap at least the one PUCCH resource regardless of the CC the PUSCH resource is associated with, which means the one or more PUSCH resources may be in the same CC or different CCs from the first CC.

At block 403, the UE multiplexes one or more of the one or more first UCI messages and the one or more second UCI messages onto one or more of the one or more PUSCH resources. Within the execution environment of uplink communication logic 1102, UE 115 may determine whether any of the UCI messages are to be multiplexed on one of the PUSCH resources or whether each of the UCI messages are to be multiplexed on a respective PUSCH resource. UE 115 may then executed, under control of controller 280, uplink message generator logic 1103, stored in memory 282. The execution environment of uplink message generator logic 1103 provides UE 115 with functionality to generate uplink transmissions, including generating one or more PUSCH resource transmissions and multiplexing any UCI messages onto the one or more of the PUSCH resource transmissions.

At block 404, transmits the one or more PUSCH resources on an associated component carrier after the multiplexing. UE 115, under control of controller 280, may then transmit the one or more PUSCH resources via wireless radios 1100a-r and antennas 252a-r.

As described with reference to FIG. 4, the present disclosure provides techniques for multiplexing UCI messages onto PUSCH resources across different TRPs allows for higher priority UCI messages to be transmitted while preserving PUSCH transmissions that may overlap scheduled PUCCH resource transmissions in the time domain.

FIG. 5A is a block diagram illustrating UE 115 configured for UCI message multiplexing onto PUSCH resources across different TRPs according to aspects of the present disclosure. UE 115 performs UCI message multiplexing procedure 50 within as it determines, at determination stage 500, that PUCCH1 resource and PUCCH2 resource are overlapping in the time domain and are available for simultaneous PUCCH transmission and multiple PUSCH resources, PUSCH1 and PUSCH2 resources, also overlap at least one of PUCCH1 resource and PUCCH2 resource in the time domain. UE 115 selects one PUSCH resource from PUSCH1 resource and PUSCH2 resource for UCI multiplexing procedure 50. In one example implementation, UE 115 may select a PUSCH from PUSCH1 resource and PUSCH2 resource that overlap with both PUCCH1 and PUCCH2 resources. In such example, PUSCH1 resource overlaps with both PUCCH1 and PUCCH2 resources, so UE 115 would select PUSCH1 resource for UCI multiplexing.

In an additional example implementation, UE 115 may determine more than one PUSCH resources overlap with both PUCCH1 and PUCCH2 resources. In such example implementation, UE 115 may apply the PUSCH priority rule identified in Rel. 15 among the more than one PUSCH resources overlapping with both PUCCH1 and PUCCH2 resources. The Rel. 15 PUSCH priority rule identifies the priority PUSCH resource using the associated CC index first followed by the starting time of the resource. Thus, the priority PUSCH resource would be determined to have the lowest associated CC index first and the earliest starting time second. If more than one PUSCH resource share the lowest CC index, the PUSCH resource with the earliest starting time would then be identified as the priority PUSCH resource.

In a first optional aspect illustrated in FIG. 5A, when a PUSCH resource is selected from multiple overlapping PUSCH resources, the UCI messages of PUCCH1 and PUCCH2 resources, UCI1, which includes a HARQ ACK1, and UCI2, which includes a HARQ ACK2, would each be multiplexed onto the selected PUSCH resource. Thus, as illustrated, after determining to select PUSCH1 resource at determination stage 500, UE 115 multiplexes UCI1 and UCI2 onto PUSCH1 resource at multiplexing stage 501. UE 115 may then transmit PUSCH1 resource, including UCI1 and UCI2, and PUSCH2 resource for one or both of TRPs 105x and 105y and not transmit either of PUCCH1 or PUCCH2 resources.

It should be noted that, within determination stage 500, UE 115 may use various different methods for selecting the “priority” PUSCH resource. For example, instead of the Rel. 15 priority rules, UE 115 may use a reverse criteria by first selecting the PUSCH resource having the earliest starting time and resolving multiple PUSCH having the same start time by selecting the one with a lowest CC index, or a further variation may be resolving multiple PUSCH having the same starting time with a highest CC index selection. Any combination or other criteria for selection may be used. No single method of selecting one PUSCH from multiple overlapping PUSCH is required according to the various aspects of the present disclosure.

FIG. 5B is a block diagram illustrating UE 115 configured for UCI message multiplexing onto PUSCH resources across different TRPs according to aspects of the present disclosure. UE 115 performs UCI message multiplexing procedure 51, which may be a variation of the first optional aspect illustrated in FIG. 5A. Again, in determination stage 500, UE 115 determines that PUCCH1 and PUCCH2 resources are overlapping in the time domain and available for simultaneous transmission, and that one or more PUSCH resources, PUSCH1 and PUSCH2 resources, overlap in the time domain with one or more of PUCCH1 resource and PUCCH2 resource. However, as illustrated in FIG. 5B, neither PUSCH1 resource nor PUSCH2 resource overlaps with both PUCCH1 resource and PUCCH2 resource.

In such a scenario, UE 115 would again select a first PUSCH resource from the one or more PUSCHs that overlap with PUCCH1 resource using one of various methods. UE 115 would then select another PUSCH resource of the multiple PUSCH resources that overlap with PUCCH2 resource, again, using one of various selection criteria. In multiplexing stage 501, UE 115 would multiplex UCI1 onto PUSCH1 resource and UCI2 onto PUSCH2 resource. Similarly, UE 115 would then transmit PUSCH1, including UCI1, and PUSCH2, including UCI2, to one or both of TRPs 105x and 105y, without transmitting either PUCCH1 or PUCCH2 resources.

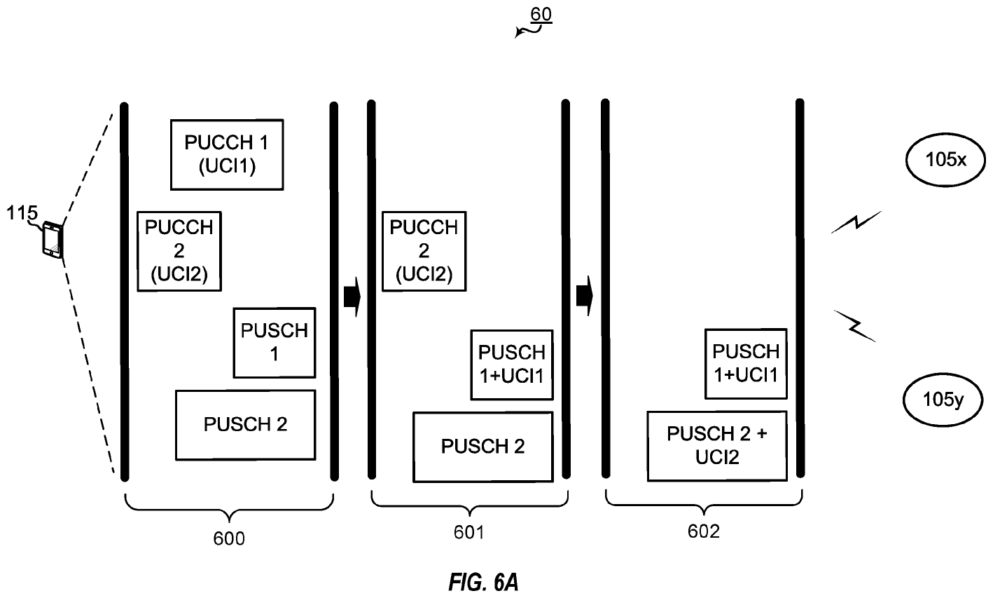

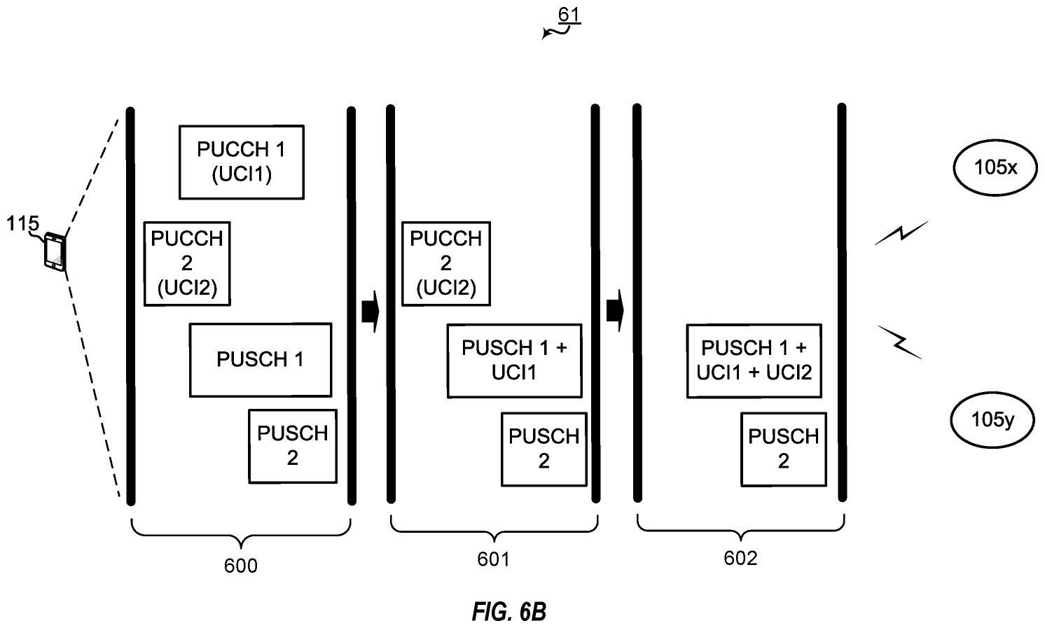

FIG. 6A is a block diagram illustrating UE 115 configured for UCI message multiplexing onto PUSCH resources across different TRPs according to aspects of the present disclosure. UCI message multiplexing procedure 60 provides a second optional aspect according to the current disclosure. Within determination stage 600, UE 115 determines that at least one of multiple PUSCH resources, PUSCH1 and PUSCH2 resources, overlaps with at least one of PUCCH1 and PUCCH2 resources. UCI message multiplexing procedure 60 includes UE 115 selecting a first PUSCH resource from PUSCH1 and PUSCH2 resources that overlap with PUCCH1 resource using one of a variety of selection criteria. UE 115 selects PUSCH1, which overlaps in the time domain with PUCCH1.

In first multiplexing stage 601, UE 115 multiplexes UCI1 onto PUSCH1. Also within first multiplexing stage 601, UE 115 selects another PUSCH resource from the multiple PUSCH resources that overlap with PUCCH2 resource using one or a variety of selection criteria. As illustrated in FIG. 6A, UE 115 selects PUSCH2 resource, which overlaps in the time domain with PUCCH2 resource. UE 115, in a second multiplexing stage 602, multiplexes UCI2 onto PUSCH2 resource. UE 115 may then transmit PUSCH1 resource, including UCI1, and PUSCH2 resource, including UCI2, to one or both of TRPs 105x and 105y, and does not transmit PUCCH1 and PUCCH2 resources.

FIG. 6B is a block diagram illustrating UE 115 configured for UCI message multiplexing onto PUSCH resources across different TRPs according to aspects of the present disclosure. In a variation to the second optional aspect, the PUSCH resources selected by UE 115 may result in the selected PUSCH resources being the same PUSCH resource. For example, in determination stage 600, UE 115 selects PUSCH1 resource using one of a variety of selection criteria for the one or more first UCI, e.g., UCI1, in overlapping PUCCH1 resource in the time domain. UE 115 multiplexes UCI1 onto PUSCH1 resource in first multiplexing stage 601. Within first multiplexing stage 601, UE 115 also selects PUSCH1 resource for the one or more second UCI, e.g., UCI2, in overlapping PUCCH2 resource in the time domain. UE 115 multiplexes UCI2 also onto PUSCH1 resource in second multiplexing stage 602. UE 115 may then transmit PUSCH1, including both UCI1 and UCI2, and PUSCH2 resource to one or both of TRPs 105x and 105y, without transmitting PUCCH1 or PUCCH2 resources.

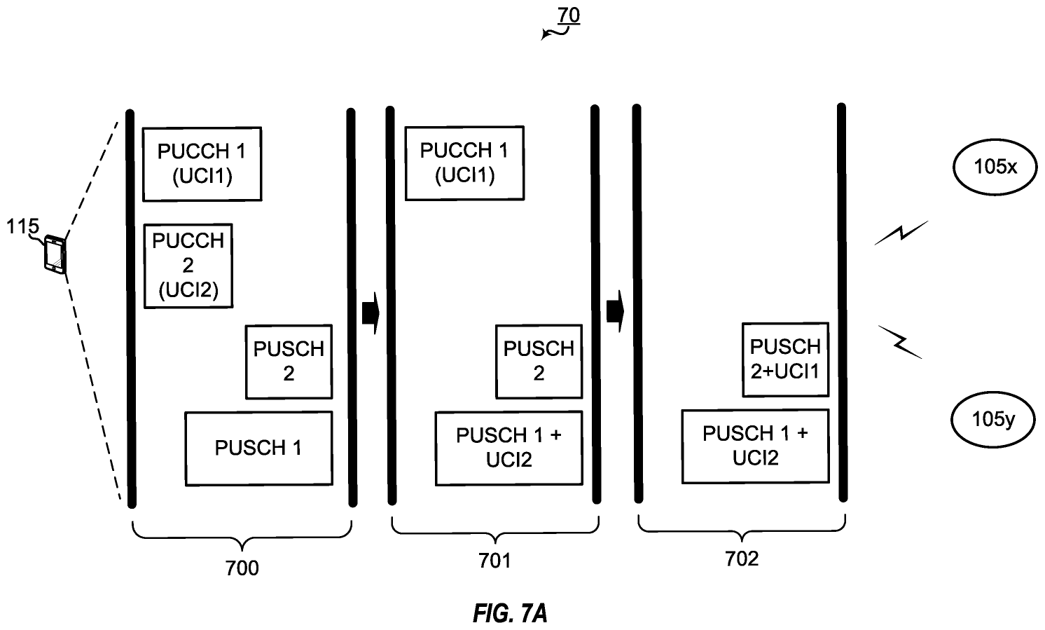

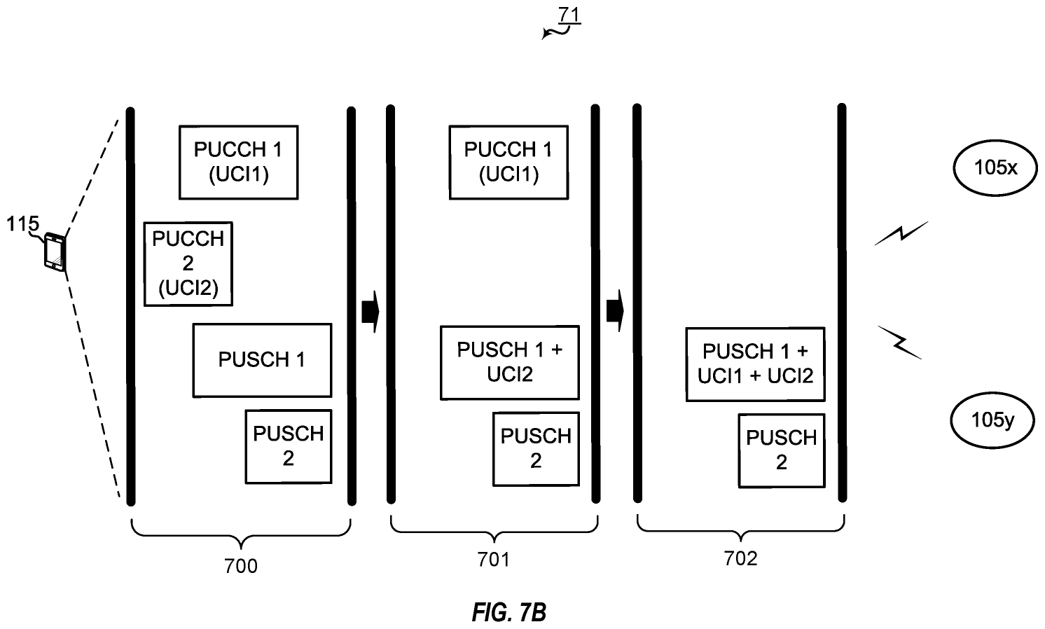

FIG. 7A is a block diagram illustrating UE 115 configured for UCI message multiplexing onto PUSCH resources across different TRPs according to aspects of the present disclosure. UCI message multiplexing procedure 70 provides a third optional aspect according to the current disclosure. The third optional aspects provides for UE 115 to select one PUSCH resource of the multiple PUSCH resources, determined in determination stage 700 as overlapping one or more of the multiple PUCCH resources available for simultaneous PUCCH transmission, PUCCH1 and PUCCH2 resources, that overlaps in the time domain with the PUCCH resource having the earliest start time. In such third optional aspect, PUCCH2 has the earliest start time.

As illustrated in FIG. 7A, PUCCH1 and PUCCH2 resources have the same starting time. In such an instance, UE 115 selects the PUCCH resource according to its associated CORESET pool index value. In one example implementation, UE 115 may select the PUCCH resource associated with the highest CORESET pool index value. Alternative implementations may use the lowest CORESET pool index value or other criteria. In the illustrated example, PUCCH 2 resource is associated with the highest CORESET pool index value. Accordingly, UE 115 selects a PUSCH resource, PUSCH 1, of the multiple PUSCH resources, that overlaps PUCCH2 in the time domain. As above, UE 115 uses one of a variety of criteria for selecting the PUSCH resource.

In first multiplexing stage 701, UE 115 multiplexes UCI2 onto PUSCH1 resource and selects another PUSCH resource, PUSCH2 resource, from the multiple PUSCH resources that overlaps the later starting time PUCCH resource, PUCCH1 resource, in the time domain. Again, UE 115 selects PUSCH2 resource using one of the variety of criteria. UE 115 may then multiplex UCI1 onto PUSCH2 resource at second multiplexing stage 702. UE 115 transmits PUSCH1, including UCI2, and PUSCH2, including UCI1, to one or both of TRPs 105x and 105y without transmitting PUCCH1 or PUCCH2 resources.

FIG. 7B is a block diagram illustrating UE 115 configured for UCI message multiplexing onto PUSCH resources across different TRPs according to aspects of the present disclosure. UCI message multiplexing procedure 71 provides a variation to the third optional aspect according to the current disclosure in which the PUSCH resources selected by UE 115 may result in selection of the same PUSCH resource. For example, in determination stage 700, UE 115 selects PUSCH1 resource from one or more PUSCH resources that overlap in the time domain with the PUCCH resource having the earliest starting time, e.g., PUCCH2 using one of a variety of selection criteria. UE 115 multiplexes UCI2 onto PUSCH1 resource in first multiplexing stage 701 and also selects PUSCH1 resource as PUSCH resource from one or more PUSCH resources that overlap in the time domain with the PUCCH resource having the later starting time, e.g., PUCCH1. UE 115 multiplexes UCI1 also onto PUSCH1 resource in second multiplexing stage 702. UE 115 may then transmit PUSCH1, including both UCI1 and UCI2, and PUSCH2 resource to one or both of TRPs 105x and 105y, without transmitting PUCCH1 or PUCCH2 resources

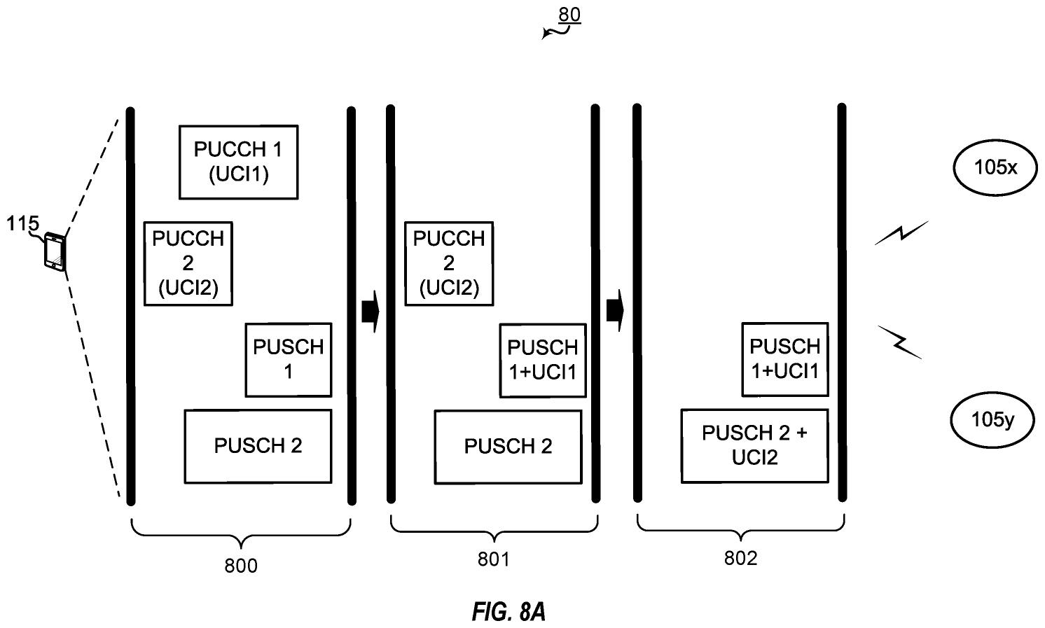

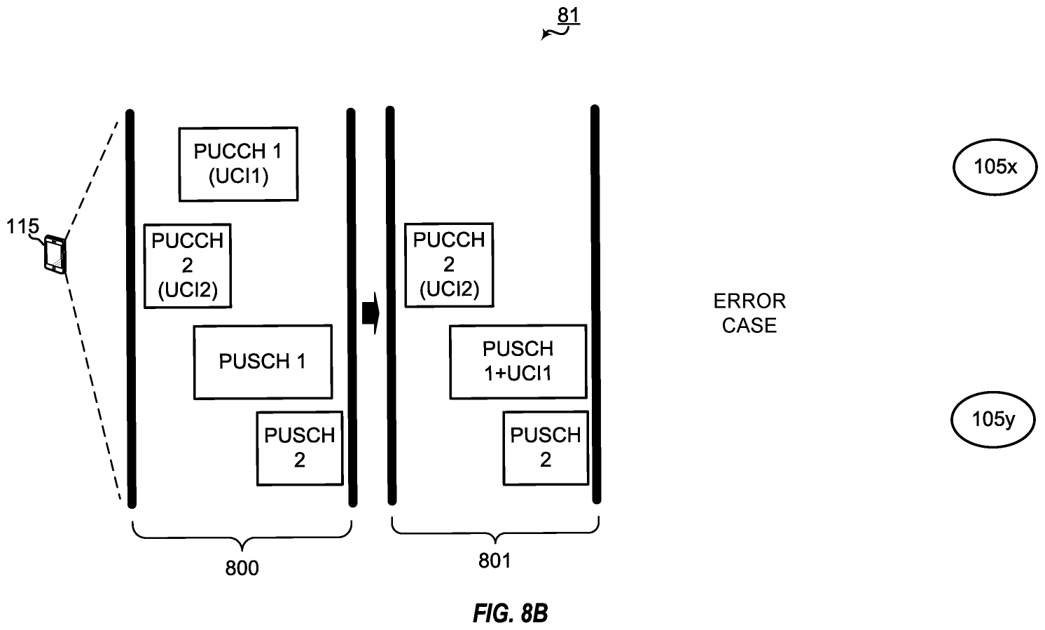

FIG. 8A is a block diagram illustrating UE 115 configured for UCI message multiplexing onto PUSCH resources across different TRPs according to aspects of the present disclosure. UCI message multiplexing procedure 80 provides a fourth optional aspect according to the current disclosure. Within determination stage 800, UE 115 determines that at least one of multiple PUSCH resources, PUSCH1 and PUSCH2 resources, overlaps with at least one of PUCCH1 and PUCCH2 resources. UCI message multiplexing procedure 80 includes UE 115 selecting a first PUSCH resource from PUSCH1 and PUSCH2 resources that overlap with PUCCH1 resource using one of a variety of selection criteria. UE 115 selects PUSCH1, which overlaps in the time domain with PUCCH1.

In first multiplexing stage 801, UE 115 multiplexes UCI1 onto PUSCH1. Also within first multiplexing stage 801, UE 115 selects another PUSCH resource from the remaining multiple PUSCH resources other than PUSCH1 resource that overlap with PUCCH2 resource using one of a variety of selection criteria. As illustrated in FIG. 8A, UE 115 selects PUSCH2 resource, which overlaps in the time domain with PUCCH2 resource. UE 115, in a second multiplexing stage 802, multiplexes UCI2 onto PUSCH2 resource. UE 115 may then transmit PUSCH1 resource, including UCI1, and PUSCH2 resource, including UCI2, to one or both of TRPs 105x and 105y, and does not transmit PUCCH1 and PUCCH2 resources.

FIG. 8B is a block diagram illustrating UE 115 configured for UCI message multiplexing onto PUSCH resources across different TRPs according to aspects of the present disclosure. UCI message multiplexing procedure 81 provides a variation to the fourth optional aspect. The processes within determination stage 800 occur similarly to determination stage 800 in FIG. 8A, UE 115 selects PUSCH1, which overlaps in the time domain with PUCCH1. However, among the remaining multiple PUSCH resources, PUSCH2 resource does not overlap PUCCH2. As Rel. 18 currently does not support simultaneous PUCCH/PUSCH transmission, UE 115 could not simply transmit PUCCH2 resource, PUSCH1 resource with UCI1, and PUSCH2 resource. As UCI with HARQ-ACK/NACK has priority over PUSCH resources, UE 115 should not drop either PUCCH2 or PUSCH1 with UCI1. As illustrated in FIG. 8B, in response to the failure of a remaining PUSCH resource overlapping with PUCCH2 resource, UE 115 declares an error state. With the error state declared, either the network may not make such scheduling or if such scheduling happens, UE 115 may determine which of PUCCH reousr or PUSCH to transmit. For example, UE 115 may simultaneously transmit PUCCH1 and PUCCH2 resources and drop PUSCH1 and PUSCH2 resources or UE 115 may drop PUCCH2 and simultaneously transmit PUSCH1 including UCI1 and PUSCH2 or UE may transmit nothing.

It should be noted that, alternatively to declaring an error state, UE 115 may fall back to a different optional aspect. For example, when the error state circumstance occurs, UE 115 may fall back to the second or third optional aspects, in which each of the UCIs of the overlapping PUCCH resources, may be multiplexed onto the same selected overlapping PUSCH resource.

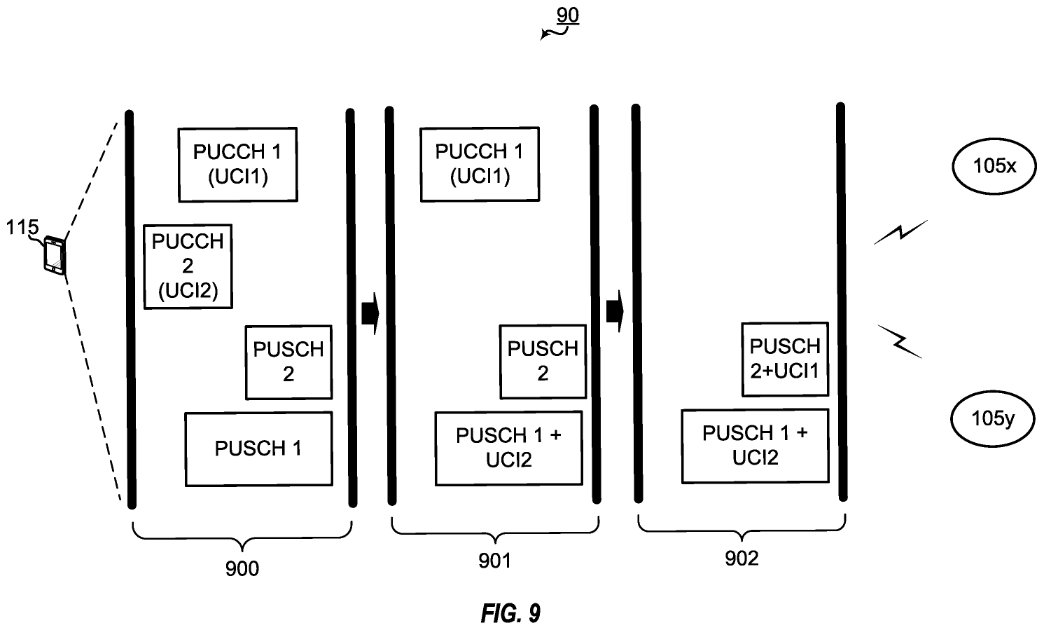

FIG. 9 is a block diagram illustrating UE 115 configured for UCI message multiplexing onto PUSCH resources across different TRPs according to aspects of the present disclosure. UCI message multiplexing procedure 90 provides a fifth optional aspect according to the current disclosure. Similar to the third optional aspect, as illustrated in FIGS. 7A and 7B, in determination stage 900, UE 115 selects one PUSCH resource of the multiple overlapping PUSCH resources that overlaps in the time domain with the PUCCH resource having the earliest start time. UE 115 identifies PUCCH2 resource as having the earlier starting time than PUCCH1 resource. UE 115 then selects PUSCH1 resource as overlapping PUCCH2 resource in the time domain.

As with the third optional aspect illustrated in FIG. 7A, should any two or more overlapping PUCCH resources have the same starting time, UE 115 may select the first PUCCH resource according to one of a variety of criteria, such as the CORESET pool index value associated with the PUCCH resources.

At first multiplexing stage 901, UE 115 multiplexes UCI2 onto PUSCH1 resource. UE 115 also identifies a next PUSCH resource of the remaining multiple PUSCH resources other than PUSCH1 resource that overlap with the PUCCH resource having the later starting time, e.g., PUCCH1 resource. As PUSCH2 resource overlaps with the later starting PUCCH1 resource, UE 115 may further select PUSCH2 resource as the next PUSCH resource. At second multiplexing stage 902, UE 115 multiplexes UCI1 onto PUSCH2 resource. UE 115 may then transmit PUSCH1 resource, including UCI2, and PUSCH2 resource, including UCI1, to one or both of TRPs 105x and 105y without transmitting PUCCH1 and PUCCH2 resources.

It should be noted that, similar to the fourth optional aspect, after selecting the PUSCH resource that overlaps in the time domain with the PUCCH resource having the earlier starting time, should none of the remaining PUSCH resources of the multiple overlapping PUSCH resources overlap the PUCCH resource having the later starting time, UE 115 may either fall back to the operations of the second or third optional aspect or declare an error state, as noted with regard to FIG. 8B.

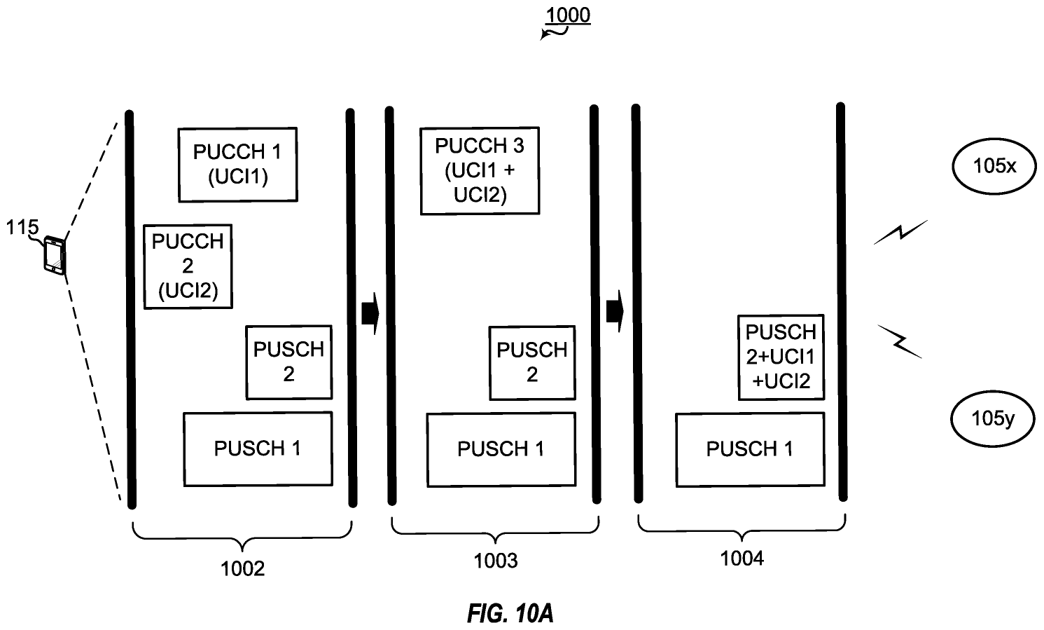

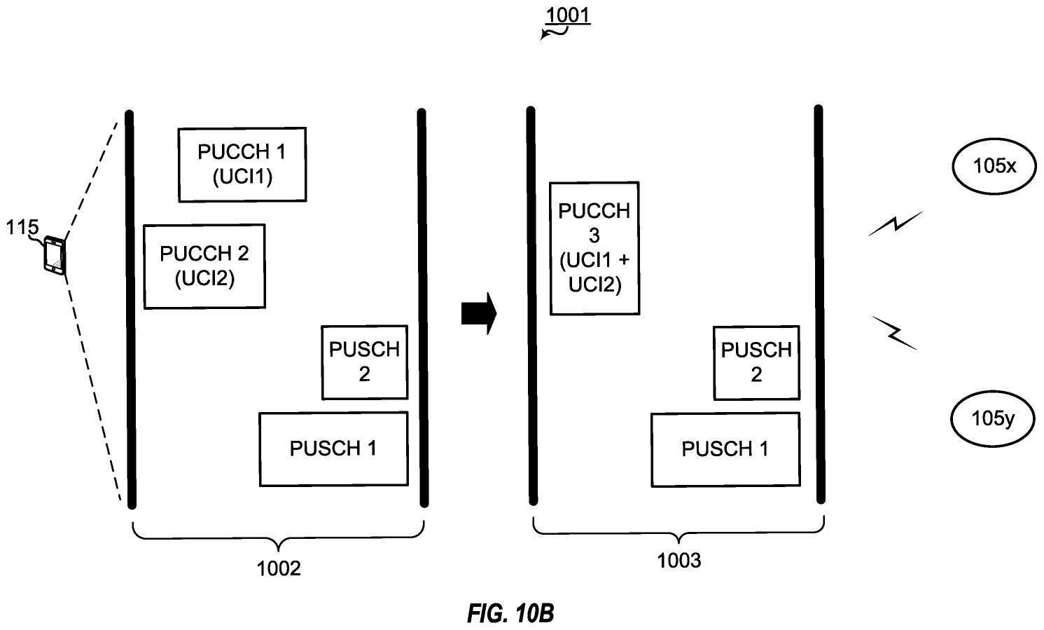

FIG. 10A is a block diagram illustrating UE 115 configured for UCI message multiplexing onto PUSCH resources across different TRPs according to aspects of the present disclosure. UCI message multiplexing procedure 1000 provides a sixth optional aspect according to the current disclosure. At determination stage 1002, UE 115 determines that PUCCH1 resource and PUCCH2 resource overlap in the time domain and are available for simultaneous PUCCH transmission. UE 115 also determines that multiple PUSCH resources, PUSCH1 and PUSCH2 resources, overlap with at least one of PUCCH1 and PUCCH2 resources. At first multiplexing stage 1003, UE 115 multiplexes UCI1 and UCI2 into a single PUCCH resource, e.g., a new PUCCH resource, PUCCH3 resource. UE 115 may then determine whether any of the multiple overlapping PUSCH resources overlaps in the time domain with PUCCH3 resource. At second multiplexing stage 1004, UE 115 multiplexes UCI1 and UCI2 from PUCCH3 onto PUSCH2 using one of a variety of selection criteria. UE 115 may then transmit PUSCH1 resource and PUSCH2 resource, with UCI1 and UCI2, to one or both of TRPs 105x and 105y, without transmitting PUCCH3 resource.

FIG. 10B is a block diagram illustrating UE 115 configured for UCI message multiplexing onto PUSCH resources across different TRPs according to aspects of the present disclosure. UCI message multiplexing procedure 1001 provides a variation to the sixth optional aspect according to the current disclosure. After determination stage 1002, in which UE 115 identifies PUCCH1 and PUCCH2 resources as overlapping and available for simultaneous transmission and identifies PUSCH1 and PUSCH2 resources as overlapping in the time domain with at least one of PUCCH1 or PUCCH2 resources, and first multiplexing stage 1003, where UE 115 multiplexes UCI1 and UCI2 onto PUCCH3 resource, UE 115 determines that neither PUSCH1 resource nor PUSCH2 resource overlaps with PUCCH3 resource. In such a scenario, because PUCCH3 resource does not overlap in the time domain with either PUSCH1 or PUSCH2 resources, UE 115 may transmit PUCCH3 resource, including UCI1 and UCI2, PUSCH1 resource, and PUSCH2 resource to one or both of TRPs 105x and 105y.

The various aspects of the present disclosure illustrated and described with respect to FIGS. 5A-10B present six optional aspects of the current disclosure defining UCI multiplexing across different CORESET pool index values. It should be noted that the first optional aspect through the fifth optional aspect may be performed under one of the following conditions: In Condition 1, UCI messages may be multiplexed onto overlapping PUSCH resources irrespective of the CORESET pool index value associated with each of the one or more PUSCH resources that overlap with one or more PUCCH resources; In Condition 2, during the determination stage, UE 115 determines that at least one of PUCCH1 or PUCCH2 resources do not overlap with any PUSCH resource (in any CC) that are associated with the same CORESET pool index value as the PUCCH resource; and In Condition 3, in addition to Condition 2 which further includes the at least one PUCCH in Condition 2 overlaps with one or more PUSCH resources (in any CC) that are associated with a CORESET pool index value which is different than the CORESET pool index value associated with that PUCCH. The sixth optional aspect may be performed under Condition 3, in which case simultaneous PUCCH transmission may be problematic.

Any one or more of the first through the sixth optional aspects illustrated and described with respect to FIGS. 5A-10B may be enabled by the wireless specification. Alternatively, one of the sixth optional aspects may be enabled via RRC signaling. For example, in each of FIGS. 5A-10B, at a time prior to performing the UCI signal multiplexing procedures, one of TRPs 105x or 105y may transmit an RRC signal that would enable any of the first through the sixth optional aspects in UE 115. Alternatively, the RRC signaling may provide enablement of one of the six optional aspects depending on the presence of one of the noted conditions, Condition 1-3.

It should be noted that, for each of the first through sixth optional aspects, when a dynamically scheduled channel, such as a channel scheduled via DCI, is involved, joint timelines should be satisfied for UCI multiplexing on PUCCH or PUSCH resources.

It is noted that one or more blocks (or operations) described with reference to FIG. 4 may be combined with one or more blocks (or operations) described with reference to another of the figures. For example, one or more blocks (or operations) of FIG. 5A may be combined with one or more blocks (or operations) of FIG. 9. As another example, one or more blocks associated with FIG. 7B may be combined with one or more blocks associated with FIG. 6A. As another example, one or more blocks associated with FIG. 4 may be combined with one or more blocks (or operations) associated with FIGS. 1-2. Additionally, or alternatively, one or more operations described above with reference to FIGS. 1-2 may be combined with one or more operations described with reference to FIG. 11.

In one or more aspects, techniques for supporting UCI message multiplexing onto PUSCH resources across different base stations may include additional aspects, such as any single aspect or any combination of aspects described below or in connection with one or more other processes or devices described elsewhere herein. In one or more aspects, supporting UCI message multiplexing onto PUSCH resources across different base stations may include an apparatus configured to determine that a first PUCCH resource including one or more first UCI messages associated with a first CORESET pool index value overlaps in a time domain with a second PUCCH resource including one or more second UCI messages associated with a second CORESET pool index value. The apparatus may further be configured to identify one or more PUSCH resources that overlaps in the time domain with at least one of the first PUCCH resource or the second PUCCH resource. The apparatus may further be configured to multiplex one or more of the one or more first UCI messages and the one or more second UCI messages onto one or more of the one or more PUSCH resources, and transmit the one or more PUSCH resources on an associated component carrier after the multiplexing. Additionally, the apparatus may perform or operate according to one or more aspects as described below.

In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

A first aspect of wireless communication performed by a UE includes determining, by the UE, that a first PUCCH resource including one or more first UCI messages associated with a first CORESET pool index value overlaps in a time domain with a second PUCCH resource including one or more second UCI messages associated with a second CORESET pool index value; identifying, by the UE, one or more PUSCH resources that overlaps in the time domain with at least one of the first PUCCH resource or the second PUCCH resource; multiplexing, by the UE, one or more of the one or more first UCI messages and the one or more second UCI messages onto one or more of the one or more PUSCH resources; and transmitting, by the UE, the one or more PUSCH resources on an associated component carrier after the multiplexing.

In a second aspect, alone or in combination with the first aspect, wherein the associated component carrier is one of: a same component carrier or a different component carrier as a PUCCH component carrier on which the first PUCCH resource and the second PUCCH resource may be simultaneously transmitted.

In a third aspect, alone or in combination with one or more of the first aspect and the second aspect, wherein the identifying the one or more PUSCH resources includes: identifying a first PUSCH resource of the one or more PUSCH resources that overlaps with both of the first PUCCH resource and the second PUCCH resource, wherein the multiplexing includes multiplexing the one or more first UCI messages and the one or more second UCI messages onto the first PUSCH resource.

In a fourth aspect, alone or in combination with one or more of the first aspect through the third aspect, wherein the identifying the one or more PUSCH resources includes: identifying a first PUSCH resource of the one or more PUSCH resources that overlaps with the first PUCCH resource, wherein the one or more first UCI messages are multiplexed onto the first PUSCH resource; and identifying a second PUSCH resource of the one or more PUSCH resources that overlaps with the second PUCCH resource, wherein the one or more second UCI messages are multiplexed onto the second PUSCH resource, wherein the transmitting includes transmitting the first PUSCH resource and the second PUSCH resource.

In a fifth aspect, alone or in combination with one or more of the first aspect through the fourth aspect, wherein the identifying the first PUSCH resource and the second PUSCH resource is in response to the UE determining that a single PUSCH resource of the one or more PUSCH resources fails to overlap both of the first PUCCH resource and the second PUCCH resource.

In a sixth aspect, alone or in combination with one or more of the first aspect through the fifth aspect, wherein the first PUCCH resource is scheduled earlier in the time domain than the second PUCCH resource.

In a seventh aspect, alone or in combination with one or more of the first aspect through the sixth aspect, wherein, when the first PUCCH resource has a same starting time as the second PUCCH resource, the UE identifies the first PUSCH that overlaps the first PUCCH resource having the one or more first UCI messages associated with the first CORESET pool index value that is one of a higher value or a lower value than the second CORESET pool index value associated with the one or more second UCI messages of the second PUCCH resource.

In an eighth aspect, alone or in combination with one or more of the first aspect through the seventh aspect, wherein the first PUSCH resource and the second PUSCH resource are a same PUSCH resource.

In a ninth aspect, alone or in combination with one or more of the first aspect through the eighth aspect, wherein the identifying the one or more PUSCH includes: identifying a first PUSCH resource of the one or more PUSCH resources that overlaps with the first PUCCH resource, wherein the one or more first UCI messages are multiplexed onto the first PUSCH resource; determining whether any remaining PUSCH resource of the one or more PUSCH resources excluding the first PUSCH resource overlaps the second PUCCH resources, wherein, in response to at least one PUSCH resource overlapping with the second PUCCH resource, the one or more second UCI messages are multiplexed onto a second PUSCH resource of the at least one PUSCH resource, and wherein, in response none of the one or more PUSCH resources excluding the first PUSCH resource overlaps with the second PUCCH resource, one of: the one or more second UCI messages are multiplexed onto the first PUSCH resource when the first PUSCH resource also overlaps with the second PUCCH resource; or declaring, by the UE, an error state, wherein the UE refrains from the multiplexing and the transmitting the one or more PUSCH resources.

In a tenth aspect, alone or in combination with one or more of the first aspect through the ninth aspect, wherein the first PUCCH resource is identified for being earlier in the time domain than the second PUCCH resource.

In an eleventh aspect, alone or in combination with one or more of the first aspect through the tenth aspect, further including: multiplexing, by the UE, the one or more first UCI messages and the one or more second UCI messages onto a multiplexed PUCCH resource; determining, by the UE, whether any PUSCH resource of the one or more PUSCH resources overlaps with the multiplexed PUCCH resource, wherein, in response to at least one PUSCH resource of the one or more PUSCH resources overlapping with the multiplexed PUCCH resource, the one or more first UCI messages and the one or more second UCI messages are multiplexed onto a first PUSCH resource of the at least one PUSCH resource, and wherein, in response to none of the one or more PUSCH resources overlaps with the multiplexed PUCCH resource, transmitting, by the UE, the multiplexed PUCCH resource and the one or more PUSCH resources.

In a twelfth aspect, alone or in combination with one or more of the first aspect through the eleventh aspect, wherein the multiplexing the one or more first UCI messages and the one or more second UCI messages onto the multiplexed PUCCH resource, and the determining whether the PUSCH resource overlaps with the multiplexed PUCCH resource is performed in response to: identification of at least one PUCCH resource of the first PUCCH resource or the second PUCCH resource that overlaps with at least one PUSCH resource of the one or more PUSCH resources in which the CORESET pool index value associated with the at least one PUSCH resource is different than the corresponding CORESET pool index value associated with the at least one PUCCH resource; and identification of the at least one PUCCH resource of the first PUCCH resource or the second PUCCH resource that does not overlap with any PUSCH resource of the one or more PUSCH resources in which the CORESET pool index value associated with the any PUSCH resource is equal to the corresponding CORESET pool index value associated with the at least one PUCCH resource.

In a thirteenth aspect, alone or in combination with one or more of the first aspect through the twelfth aspect, further including: receiving, by the UE, a RRC message including a PUSCH multiplexing parameter that identifies a predetermined procedure for the identifying the one or more PUSCH resources that overlaps in the time domain with the at least one of the first PUCCH resource or the second PUCCH resource.

In a fourteenth aspect, alone or in combination with one or more of the first aspect through the thirteenth aspect, wherein the multiplexing the one or more of the one or more first UCI messages and the one or more second UCI messages onto the one or more of the one or more PUSCH resources includes one or more of: identification of the one or more PUSCH resources irrespective of a CORESET pool value associated with the one or more PUSCH resources that overlap with one or both of the first PUCCH resource and the second PUCCH resource; identification of at least one PUCCH resource of the first PUCCH resource or the second PUCCH resource that does not overlap with any PUSCH resource of the one or more PUSCH resources in which the CORESET pool value associated with the at least one PUSCH resource is equal to a corresponding CORESET pool value associated with the at least one PUCCH resource; or identification of the at least one PUCCH resource of the first PUCCH resource or the second PUCCH resource that overlaps with at least one PUSCH resource in which the CORESET pool value associated with the at least one PUSCH resource is different than the corresponding CORESET pool value associated with the at least one PUCCH resource.

In a fifteenth aspect, alone or in combination with one or more of the first aspect through the fourteenth aspect, further including: refraining, by the UE, from transmission of the first PUCCH resource and the second PUCCH resource in response to the transmitting the one or more PUSCH resources.

A sixteenth aspect may include a UE configured for wireless communication including at least one processor; and a memory coupled to the at least one processor. The at least one processor is configured to determining, by the UE, that a first PUCCH resource including one or more first UCI messages associated with a first CORESET pool index value overlaps in a time domain with a second PUCCH resource including one or more second UCI messages associated with a second CORESET pool index value; to identify, by the UE, one or more PUSCH resources that overlaps in the time domain with at least one of the first PUCCH resource or the second PUCCH resource; to multiplex, by the UE, one or more of the one or more first UCI messages and the one or more second UCI messages onto one or more of the one or more PUSCH resources; and to transmit, by the UE, the one or more PUSCH resources on an associated component carrier after executing the configuration to multiplex.

In a seventeenth aspect, alone or in combination with the sixteenth aspect, wherein the associated component carrier is one of: a same component carrier or a different component carrier as a PUCCH component carrier on which the first PUCCH resource and the second PUCCH resource may be simultaneously transmitted.

In an eighteenth aspect, alone or in combination with one or more of the sixteenth aspect and the seventeenth aspect, wherein the configuration of the at least one processor to identify the one or more PUSCH resources includes configuration of the at least one processor to identify a first PUSCH resource of the one or more PUSCH resources that overlaps with both of the first PUCCH resource and the second PUCCH resource, wherein the configuration of the at least one processor to multiplex includes configuration of the at least one processor to multiplex the one or more first UCI messages and the one or more second UCI messages onto the first PUSCH resource.

In a nineteenth aspect, alone or in combination with one or more of the sixteenth aspect through the eighteenth aspect, wherein the configuration of the at least one processor to identify the one or more PUSCH resources includes configuration of the at least one processor: to identify a first PUSCH resource of the one or more PUSCH resources that overlaps with the first PUCCH resource, wherein the one or more first UCI messages are multiplexed onto the first PUSCH resource; and to identify a second PUSCH resource of the one or more PUSCH resources that overlaps with the second PUCCH resource, wherein the one or more second UCI messages are multiplexed onto the second PUSCH resource, wherein the configuration of the at least one processor to transmit includes configuration of the at least one processor to transmit the first PUSCH resource and the second PUSCH resource.

In a twentieth aspect, alone or in combination with one or more of the sixteenth aspect through the nineteenth aspect, wherein the configuration of the at least one processor to identify the first PUSCH resource and the second PUSCH resource is in response to the UE determining that a single PUSCH resource of the one or more PUSCH resources fails to overlap both of the first PUCCH resource and the second PUCCH resource.

In a twenty-first aspect, alone or in combination with one or more of the sixteenth aspect through the twentieth aspect, wherein the first PUCCH resource is scheduled earlier in the time domain than the second PUCCH resource.

In a twenty-second aspect, alone or in combination with one or more of the sixteenth aspect through the twenty-first aspect, wherein, when the first PUCCH resource has a same starting time as the second PUCCH resource, the UE identifies the first PUSCH that overlaps the first PUCCH resource having the one or more first UCI messages associated with the first CORESET pool index value that is one of a higher value or a lower value than the second CORESET pool index value associated with the one or more second UCI messages of the second PUCCH resource.

In a twenty-third aspect, alone or in combination with one or more of the sixteenth aspect through the twenty-second aspect, wherein the first PUSCH resource and the second PUSCH resource are a same PUSCH resource.

In a twenty-fourth aspect, alone or in combination with one or more of the sixteenth aspect through the twenty-third aspect, wherein the configuration of the at least one processor to identify the one or more PUSCH includes configuration of the at least one processor: to identify a first PUSCH resource of the one or more PUSCH resources that overlaps with the first PUCCH resource, wherein the one or more first UCI messages are multiplexed onto the first PUSCH resource; to determine whether any remaining PUSCH resource of the one or more PUSCH resources excluding the first PUSCH resource overlaps the second PUCCH resources, wherein, in response to at least one PUSCH resource overlapping with the second PUCCH resource, the one or more second UCI messages are multiplexed onto a second PUSCH resource of the at least one PUSCH resource, and wherein, in response none of the one or more PUSCH resources excluding the first PUSCH resource overlaps with the second PUCCH resource, one of: the one or more second UCI messages are multiplexed onto the first PUSCH resource when the first PUSCH resource also overlaps with the second PUCCH resource; or an error state is declared by the UE, wherein the UE refrains from execution of the configuration of the at least one processor to multiplex and to transmit the one or more PUSCH resources.

In a twenty-fifth aspect, alone or in combination with one or more of the sixteenth aspect through the twenty-fourth aspect, wherein the first PUCCH resource is identified for being earlier in the time domain than the second PUCCH resource.

In a twenty-sixth aspect, alone or in combination with one or more of the sixteenth aspect through the twenty-fifth aspect, further including configuration of the at least one processor: to multiplex, by the UE, the one or more first UCI messages and the one or more second UCI messages onto a multiplexed PUCCH resource; to determine, by the UE, whether any PUSCH resource of the one or more PUSCH resources overlaps with the multiplexed PUCCH resource, wherein, in response to at least one PUSCH resource of the one or more PUSCH resources overlapping with the multiplexed PUCCH resource, the one or more first UCI messages and the one or more second UCI messages are multiplexed onto a first PUSCH resource of the at least one PUSCH resource, and wherein, in response to none of the one or more PUSCH resources overlapping with the multiplexed PUCCH resource, execute a configuration of the at least one processor to transmit, by the UE, the multiplexed PUCCH resource and the one or more PUSCH resources.

In a twenty-seventh aspect, alone or in combination with one or more of the sixteenth aspect through the twenty-sixth aspect, wherein the configuration of the at least one processor to multiplex the one or more first UCI messages and the one or more second UCI messages onto the multiplexed PUCCH resource, and the configuration of the at least one processor to determine whether the PUSCH resource overlaps with the multiplexed PUCCH resource is performed in response to: identification of at least one PUCCH resource of the first PUCCH resource or the second PUCCH resource that overlaps with at least one PUSCH resource of the one or more PUSCH resources in which the CORESET pool index value associated with the at least one PUSCH resource is different than the corresponding CORESET pool index value associated with the at least one PUCCH resource; and identification of the at least one PUCCH resource of the first PUCCH resource or the second PUCCH resource that does not overlap with any PUSCH resource of the one or more PUSCH resources in which the CORESET pool index value associated with the any PUSCH resource is equal to the corresponding CORESET pool index value associated with the at least one PUCCH resource.

In a twenty-eighth aspect, alone or in combination with one or more of the sixteenth aspect through the twenty-seventh aspect, further including configuration of the at least one processor to receive, by the UE, a RRC message including a PUSCH multiplexing parameter that identifies a predetermined procedure for the identifying the one or more PUSCH resources that overlaps in the time domain with the at least one of the first PUCCH resource or the second PUCCH resource.

In a twenty-ninth aspect, alone or in combination with one or more of the sixteenth aspect through the twenty-eighth aspect, wherein the configuration of the at least one processor to multiplex the one or more of the one or more first UCI messages and the one or more second UCI messages onto the one or more of the one or more PUSCH resources includes one or more of: identification of the one or more PUSCH resources irrespective of a CORESET pool value associated with the one or more PUSCH resources that overlap with one or both of the first PUCCH resource and the second PUCCH resource; identification of at least one PUCCH resource of the first PUCCH resource or the second PUCCH resource that does not overlap with any PUSCH resource of the one or more PUSCH resources in which the CORESET pool value associated with at least one PUSCH resource is equal to a corresponding CORESET pool value associated with the at least one PUCCH resource; or identification of the at least one PUCCH resource of the first PUCCH resource or the second PUCCH resource that overlaps with the at least one PUSCH resource in which the CORESET pool value associated with the at least one PUSCH resource is different than the corresponding CORESET pool value associated with the at least one PUCCH resource.

In a thirtieth aspect, alone or in combination with one or more of the sixteenth aspect through the twenty-ninth aspect, further including configuration of the at least one processor to refrain, by the UE, from transmission of the first PUCCH resource and the second PUCCH resource in response to the execution of the configuration of the at least one processor to transmit the one or more PUSCH resources.

A thirty-first aspect may include a UE configured for wireless communication, that includes means for determining, by the UE, that a first PUCCH resource including one or more first UCI messages associated with a first CORESET pool index value overlaps in a time domain with a second PUCCH resource including one or more second UCI messages associated with a second CORESET pool index value; means for identifying, by the UE, one or more PUSCH resources that overlaps in the time domain with at least one of the first PUCCH resource or the second PUCCH resource; means for multiplexing, by the UE, one or more of the one or more first UCI messages and the one or more second UCI messages onto one or more of the one or more PUSCH resources; and means for transmitting, by the UE, the one or more PUSCH resources on an associated component carrier after the means for multiplexing.

In a thirty-second aspect, alone or in combination with the thirty-first aspect, wherein the associated component carrier is one of: a same component carrier or a different component carrier as a PUCCH component carrier on which the first PUCCH resource and the second PUCCH resource may be simultaneously transmitted.

In a thirty-third aspect, alone or in combination with one or more of the thirty-first aspect and the thirty-second aspect, wherein the means for identifying the one or more PUSCH resources includes: means for identifying a first PUSCH resource of the one or more PUSCH resources that overlaps with both of the first PUCCH resource and the second PUCCH resource, wherein the means for multiplexing includes means for multiplexing the one or more first UCI messages and the one or more second UCI messages onto the first PUSCH resource.

In a thirty-fourth aspect, alone or in combination with one or more of the thirty-first aspect through the thirty-third aspect, wherein means for the identifying the one or more PUSCH resources includes: means for identifying a first PUSCH resource of the one or more PUSCH resources that overlaps with the first PUCCH resource, wherein the one or more first UCI messages are multiplexed onto the first PUSCH resource; and means for identifying a second PUSCH resource of the one or more PUSCH resources that overlaps with the second PUCCH resource, wherein the one or more second UCI messages are multiplexed onto the second PUSCH resource, wherein the means for transmitting includes means for transmitting the first PUSCH resource and the second PUSCH resource.

In a thirty-fifth aspect, alone or in combination with one or more of the thirty-first aspect through the thirty-fourth aspect, wherein the means for identifying the first PUSCH resource and the second PUSCH resource is in response to the UE determining that a single PUSCH resource of the one or more PUSCH resources fails to overlap both of the first PUCCH resource and the second PUCCH resource.

In a thirty-sixth aspect, alone or in combination with one or more of the thirty-first aspect through the thirty-fifth aspect, wherein the first PUCCH resource is scheduled earlier in the time domain than the second PUCCH resource.

In a thirty-seventh aspect, alone or in combination with one or more of the thirty-first aspect through the thirty-sixth aspect, when the first PUCCH resource has a same starting time as the second PUCCH resource, the UE identifies the first PUSCH that overlaps the first PUCCH resource having the one or more first UCI messages associated with the first CORESET pool index value that is one of a higher value or a lower value than the second CORESET pool index value associated with the one or more second UCI messages of the second PUCCH resource.

In a thirty-eighth aspect, alone or in combination with one or more of the thirty-first aspect through the thirty-seventh aspect, wherein the first PUSCH resource and the second PUSCH resource are a same PUSCH resource.

In a thirty-ninth aspect, alone or in combination with one or more of the thirty-first aspect through the thirty-eighth aspect, wherein the means for identifying the one or more PUSCH includes: means for identifying a first PUSCH resource of the one or more PUSCH resources that overlaps with the first PUCCH resource, wherein the one or more first UCI messages are multiplexed onto the first PUSCH resource; means for determining whether any remaining PUSCH resource of the one or more PUSCH resources excluding the first PUSCH resource overlaps the second PUCCH resources, wherein, in response to at least one PUSCH resource overlapping with the second PUCCH resource, the one or more second UCI messages are multiplexed onto a second PUSCH resource of the at least one PUSCH resource, and wherein, in response none of the one or more PUSCH resources excluding the first PUSCH resource overlaps with the second PUCCH resource, one of: the one or more second UCI messages are multiplexed onto the first PUSCH resource when the first PUSCH resource also overlaps with the second PUCCH resource; or means for declaring, by the UE, an error state, wherein the UE refrains from executing the means for multiplexing and the means for transmitting the one or more PUSCH resources.

In a fortieth aspect, alone or in combination with one or more of the thirty-first aspect through the thirty-ninth aspect, wherein the first PUCCH resource is identified for being earlier in the time domain than the second PUCCH resource.

In a forty-first aspect, alone or in combination with one or more of the thirty-first aspect through the fortieth aspect, further including: means for multiplexing, by the UE, the one or more first UCI messages and the one or more second UCI messages onto a multiplexed PUCCH resource; means for determining, by the UE, whether any PUSCH resource of the one or more PUSCH resources overlaps with the multiplexed PUCCH resource, wherein, in response to at least one PUSCH resource of the one or more PUSCH resources overlapping with the multiplexed PUCCH resource, the one or more first UCI messages and the one or more second UCI messages are multiplexed onto a first PUSCH resource of at least one PUSCH resource, and wherein, in response to none of the one or more PUSCH resources overlaps with the multiplexed PUCCH resource, means for transmitting, by the UE, the multiplexed PUCCH resource and the one or more PUSCH resources.

In a forty-second aspect, alone or in combination with one or more of the thirty-first aspect through the forty-first aspect, wherein the means for multiplexing the one or more first UCI messages and the one or more second UCI messages onto the multiplexed PUCCH resource, and the means for determining whether the PUSCH resource overlaps with the multiplexed PUCCH resource is performed in response to: identification of at least one PUCCH resource of the first PUCCH resource or the second PUCCH resource that overlaps with at least one PUSCH resource of the one or more PUSCH resources in which the CORESET pool index value associated with the at least one PUSCH resource is different than the corresponding CORESET pool index value associated with the at least one PUCCH resource; and identification of the at least one PUCCH resource of the first PUCCH resource or the second PUCCH resource that does not overlap with any PUSCH resource of the one or more PUSCH resources in which the CORESET pool index value associated with the any PUSCH resource is equal to the corresponding CORESET pool index value associated with the at least one PUCCH resource.

In a forty-third aspect, alone or in combination with one or more of the thirty-first aspect through the forty-second aspect, further including: means for receiving, by the UE, a RRC message including a PUSCH multiplexing parameter that identifies a predetermined procedure for the means for identifying the one or more PUSCH resources that overlaps in the time domain with the at least one of the first PUCCH resource or the second PUCCH resource.

In a forty-fourth aspect, alone or in combination with one or more of the thirty-first aspect through the forty-third aspect, wherein the means for multiplexing the one or more of the one or more first UCI messages and the one or more second UCI messages onto the one or more of the one or more PUSCH resources includes one or more of: identification of the one or more PUSCH resources irrespective of a CORESET pool value associated with the one or more PUSCH resources that overlap with one or both of the first PUCCH resource and the second PUCCH resource; identification of at least one PUCCH resource of the first PUCCH resource or the second PUCCH resource that does not overlap with any PUSCH resource of the one or more PUSCH resources in which the CORESET pool value associated with at least one PUSCH resource is equal to a corresponding CORESET pool value associated with the at least one PUCCH resource; or identification of the at least one PUCCH resource of the first PUCCH resource or the second PUCCH resource that overlaps with the at least one PUSCH resource in which the CORESET pool value associated with the at least one PUSCH resource is different than the corresponding CORESET pool value associated with the at least one PUCCH resource.

In a forty-fifth aspect, alone or in combination with one or more of the thirty-first aspect through the forty-fourth aspect, further including: means for refraining, by the UE, from transmission of the first PUCCH resource and the second PUCCH resource in response to the means for transmitting the one or more PUSCH resources.

A forty-sixth aspect may include a non-transitory computer-readable medium having program code recorded thereon. The program code includes program code executable by a computer for causing the computer to determining, by the UE, that a first PUCCH resource including one or more first UCI messages associated with a first CORESET pool index value overlaps in a time domain with a second PUCCH resource including one or more second UCI messages associated with a second CORESET pool index value; program code executable by the computer for causing the computer to identify, by the UE, one or more PUSCH resources that overlaps in the time domain with at least one of the first PUCCH resource or the second PUCCH resource; program code executable by the computer for causing the computer to multiplex, by the UE, one or more of the one or more first UCI messages and the one or more second UCI messages onto one or more of the one or more PUSCH resources; and program code executable by the computer for causing the computer to transmit, by the UE, the one or more PUSCH resources on an associated component carrier after executing the program code executable by the computer for causing the computer to multiplex.

In a forty-seventh aspect, alone or in combination with the forty-sixth aspect, wherein the associated component carrier is one of: a same component carrier or a different component carrier as a PUCCH component carrier on which the first PUCCH resource and the second PUCCH resource may be simultaneously transmitted.

In a forty-eighth aspect, alone or in combination with one or more of the forty-sixth aspect and the forty-seventh aspect, wherein the program code executable by the computer for causing the computer to identify the one or more PUSCH resources includes program code executable by the computer for causing the computer to identify a first PUSCH resource of the one or more PUSCH resources that overlaps with both of the first PUCCH resource and the second PUCCH resource, wherein the program code executable by the computer for causing the computer to multiplex includes program code executable by the computer for causing the computer to multiplex the one or more first UCI messages and the one or more second UCI messages onto the first PUSCH resource.

In a forty-ninth aspect, alone or in combination with one or more of the forty-sixth aspect through the forty-eighth aspect, wherein the program code executable by the computer for causing the computer to identify the one or more PUSCH resources includes program code executable by the computer for causing the computer: to identify a first PUSCH resource of the one or more PUSCH resources that overlaps with the first PUCCH resource, wherein the one or more first UCI messages are multiplexed onto the first PUSCH resource; and to identify a second PUSCH resource of the one or more PUSCH resources that overlaps with the second PUCCH resource, wherein the one or more second UCI messages are multiplexed onto the second PUSCH resource, wherein the program code executable by the computer for causing the computer to transmit includes configuration of the at least one processor to transmit the first PUSCH resource and the second PUSCH resource.

In a fiftieth aspect, alone or in combination with one or more of the forty-sixth aspect through the forty-ninth aspect, wherein the program code executable by the computer for causing the computer to identify the first PUSCH resource and the second PUSCH resource is in response to the UE determining that a single PUSCH resource of the one or more PUSCH resources fails to overlap both of the first PUCCH resource and the second PUCCH resource.

In a fifty-first aspect, alone or in combination with one or more of the forty-sixth aspect through the fiftieth aspect, wherein the first PUCCH resource is scheduled earlier in the time domain than the second PUCCH resource.

In a fifty-second aspect, alone or in combination with one or more of the forty-sixth aspect through the fifty-first aspect, wherein, when the first PUCCH resource has a same starting time as the second PUCCH resource, the UE identifies the first PUSCH that overlaps the first PUCCH resource having the one or more first UCI messages associated with the first CORESET pool index value that is one of a higher value or a lower value than the second CORESET pool index value associated with the one or more second UCI messages of the second PUCCH resource.

In a fifty-third aspect, alone or in combination with one or more of the forty-sixth aspect through the fifty-second aspect, wherein the first PUSCH resource and the second PUSCH resource are a same PUSCH resource.

In a fifty-fourth aspect, alone or in combination with one or more of the forty-sixth aspect through the fifty-third aspect, wherein the program code executable by the computer for causing the computer to identify the one or more PUSCH includes program code executable by the computer for causing the computer: to identify a first PUSCH resource of the one or more PUSCH resources that overlaps with the first PUCCH resource, wherein the one or more first UCI messages are multiplexed onto the first PUSCH resource; to determine whether any remaining PUSCH resource of the one or more PUSCH resources excluding the first PUSCH resource overlaps the second PUCCH resources, wherein, in response to at least one PUSCH resource overlapping with the second PUCCH resource, the one or more second UCI messages are multiplexed onto a second PUSCH resource of the at least one PUSCH resource, and wherein, in response none of the one or more PUSCH resources excluding the first PUSCH resource overlaps with the second PUCCH resource, one of: the one or more second UCI messages are multiplexed onto the first PUSCH resource when the first PUSCH resource also overlaps with the second PUCCH resource; or an error state is declared by the UE, wherein the UE refrains from execution of the configuration of the at least one processor to multiplex and to transmit the one or more PUSCH resources.

In a fifty-fifth aspect, alone or in combination with one or more of the forty-sixth aspect through the fifty-fourth aspect, wherein the first PUCCH resource is identified for being earlier in the time domain than the second PUCCH resource.

In a fifty-sixth aspect, alone or in combination with one or more of the forty-sixth aspect through the fifty-fifth aspect, further including program code executable by the computer for causing the computer: to multiplex, by the UE, the one or more first UCI messages and the one or more second UCI messages onto a multiplexed PUCCH resource; to determine, by the UE, whether any PUSCH resource of the one or more PUSCH resources overlaps with the multiplexed PUCCH resource, wherein, in response to at least one PUSCH resource of the one or more PUSCH resources overlapping with the multiplexed PUCCH resource, the one or more first UCI messages and the one or more second UCI messages are multiplexed onto a first PUSCH resource of the at least one PUSCH resource, and wherein, in response to none of the one or more PUSCH resources overlapping with the multiplexed PUCCH resource, execute a program code executable by the computer for causing the computer to transmit, by the UE, the multiplexed PUCCH resource and the one or more PUSCH resources.

In a fifty-seventh aspect, alone or in combination with one or more of the forty-sixth aspect through the fifty-sixth aspect, wherein the program code executable by the computer for causing the computer to multiplex the one or more first UCI messages and the one or more second UCI messages onto the multiplexed PUCCH resource, and the program code executable by the computer for causing the computer to determine whether the PUSCH resource overlaps with the multiplexed PUCCH resource is performed in response to: identification of at least one PUCCH resource of the first PUCCH resource or the second PUCCH resource that overlaps with at least one PUSCH resource of the one or more PUSCH resources in which the CORESET pool index value associated with at least one PUSCH resource is different than the corresponding CORESET pool index value associated with the at least one PUCCH resource; and identification of the at least one PUCCH resource of the first PUCCH resource or the second PUCCH resource that does not overlap with any PUSCH resource of the one or more PUSCH resources in which the CORESET pool index value associated with the any PUSCH resource is equal to the corresponding CORESET pool index value associated with the at least one PUCCH resource.

In a fifty-eighth aspect, alone or in combination with one or more of the forty-sixth aspect through the fifty-seventh aspect, further including program code executable by the computer for causing the computer to receive, by the UE, a RRC message including a PUSCH multiplexing parameter that identifies a predetermined procedure for the identifying the one or more PUSCH resources that overlaps in the time domain with the at least one of the first PUCCH resource or the second PUCCH resource.

In a fifty-ninth aspect, alone or in combination with one or more of the forty-sixth aspect through the fifty-eighth aspect, wherein the program code executable by the computer for causing the computer to multiplex the one or more of the one or more first UCI messages and the one or more second UCI messages onto the one or more of the one or more PUSCH resources includes one or more of: identification of the one or more PUSCH resources irrespective of a CORESET pool value associated with the one or more PUSCH resources that overlap with one or both of the first PUCCH resource and the second PUCCH resource; identification of at least one PUCCH resource of the first PUCCH resource or the second PUCCH resource that does not overlap with any PUSCH resource of the one or more PUSCH resources in which the CORESET pool value associated with at least one PUSCH resource is equal to a corresponding CORESET pool value associated with the at least one PUCCH resource; or identification of the at least one PUCCH resource of the first PUCCH resource or the second PUCCH resource that overlaps with the at least one PUSCH resource in which the CORESET pool value associated with the at least one PUSCH resource is different than the corresponding CORESET pool value associated with the at least one PUCCH resource.

In a sixtieth aspect, alone or in combination with one or more of the forty-sixth aspect through the fifty-ninth aspect, further including program code executable by the computer for causing the computer to refrain, by the UE, from transmission of the first PUCCH resource and the second PUCCH resource in response to the execution of the program code executable by the computer for causing the computer to transmit the one or more PUSCH resources.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
determining, by the UE, that a first physical uplink control channel (PUCCH) resource including one or more first uplink control information (UCI) messages associated with a first control resource set (CORESET) pool index value overlaps in a time domain with a second PUCCH resource including one or more second UCI messages associated with a second CORESET pool index value;
identifying, by the UE, one or more physical uplink shared channel (PUSCH) resources that overlaps in the time domain with at least one of the first PUCCH resource or the second PUCCH resource;
multiplexing, by the UE, one or more of the one or more first UCI messages and the one or more second UCI messages onto one or more of the one or more PUSCH resources; and
transmitting, by the UE, the one or more PUSCH resources on an associated component carrier after the multiplexing.

2. The method of claim 1, wherein the associated component carrier is one of: a same component carrier or a different component carrier as a PUCCH component carrier on which the first PUCCH resource and the second PUCCH resource may be simultaneously transmitted.

3. The method of claim 1, wherein the identifying the one or more PUSCH resources includes:
identifying a first PUSCH resource of the one or more PUSCH resources that overlaps with both of the first PUCCH resource and the second PUCCH resource, wherein the multiplexing includes multiplexing the one or more first UCI messages and the one or more second UCI messages onto the first PUSCH resource.

4. The method of claim 1,
wherein the identifying the one or more PUSCH resources includes:
identifying a first PUSCH resource of the one or more PUSCH resources that overlaps with the first PUCCH resource, wherein the one or more first UCI messages are multiplexed onto the first PUSCH resource; and
identifying a second PUSCH resource of the one or more PUSCH resources that overlaps with the second PUCCH resource, wherein the one or more second UCI messages are multiplexed onto the second PUSCH resource,
wherein the transmitting includes transmitting the first PUSCH resource and the second PUSCH resource.

5. The method of claim 4, wherein the identifying the first PUSCH resource and the second PUSCH resource is in response to the UE determining that a single PUSCH resource of the one or more PUSCH resources fails to overlap both of the first PUCCH resource and the second PUCCH resource.

6. The method of claim 4, wherein the first PUCCH resource is scheduled earlier in the time domain than the second PUCCH resource.

7. The method of claim 4, wherein, when the first PUCCH resource has a same starting time as the second PUCCH resource, the UE identifies the first PUSCH that overlaps the first PUCCH resource having the one or more first UCI messages associated with the first CORESET pool index value that is one of a higher value or a lower value than the second CORESET pool index value associated with the one or more second UCI messages of the second PUCCH resource.

8. The method of claim 4, wherein the first PUSCH resource and the second PUSCH resource are a same PUSCH resource.

9. The method of claim 1, wherein the identifying the one or more PUSCH resources includes:
identifying a first PUSCH resource of the one or more PUSCH resources that overlaps with the first PUCCH resource, wherein the one or more first UCI messages are multiplexed onto the first PUSCH resource;
determining whether any remaining PUSCH resource of the one or more PUSCH resources excluding the first PUSCH resource overlaps the second PUCCH resources,
wherein, in response to at least one PUSCH resource overlapping with the second PUCCH resource, the one or more second UCI messages are multiplexed onto a second PUSCH resource of the at least one PUSCH resource, and
wherein, in response none of the one or more PUSCH resources excluding the first PUSCH resource overlaps with the second PUCCH resource, one of:
the one or more second UCI messages are multiplexed onto the first PUSCH resource when the first PUSCH resource also overlaps with the second PUCCH resource; or
declaring, by the UE, an error state, wherein the UE refrains from the multiplexing and the transmitting the one or more PUSCH resources.

10. The method of claim 9, wherein the first PUCCH resource is identified for being earlier in the time domain than the second PUCCH resource.

11. The method of claim 1, further including:
multiplexing, by the UE, the one or more first UCI messages and the one or more second UCI messages onto a multiplexed PUCCH resource;
determining, by the UE, whether any PUSCH resource of the one or more PUSCH resources overlaps with the multiplexed PUCCH resource,
wherein, in response to at least one PUSCH resource of the one or more PUSCH resources overlapping with the multiplexed PUCCH resource, the one or more first UCI messages and the one or more second UCI messages are multiplexed onto a first PUSCH resource of the at least one PUSCH resource, and
wherein, in response to none of the one or more PUSCH resources overlaps with the multiplexed PUCCH resource, transmitting, by the UE, the multiplexed PUCCH resource and the one or more PUSCH resources.

12. The method of claim 11, wherein the multiplexing the one or more first UCI messages and the one or more second UCI messages onto the multiplexed PUCCH resource, and the determining whether the PUSCH resource overlaps with the multiplexed PUCCH resource is performed in response to:
identification of at least one PUCCH resource of the first PUCCH resource or the second PUCCH resource that overlaps with at least one PUSCH resource of the one or more PUSCH resources in which the CORESET pool index value associated with the at least one PUSCH resource is different than a corresponding CORESET pool index value associated with the at least one PUCCH resource; and
identification of the at least one PUCCH resource of the first PUCCH resource or the second PUCCH resource that does not overlap with any PUSCH resource of the one or more PUSCH resources in which the CORESET pool index value associated with the any PUSCH resource is equal to the corresponding CORESET pool index value associated with the at least one PUCCH resource.

13. The method of claim 1, further including:
receiving, by the UE, a radio resource control (RRC) message including a PUSCH multiplexing parameter that identifies a predetermined procedure for the identifying the one or more PUSCH resources that overlaps in the time domain with the at least one of the first PUCCH resource or the second PUCCH resource.

14. The method of claim 1, wherein the multiplexing the one or more of the one or more first UCI messages and the one or more second UCI messages onto the one or more of the one or more PUSCH resources includes one or more of:
identification of the one or more PUSCH resources irrespective of a CORESET pool value associated with the one or more PUSCH resources that overlap with one or both of the first PUCCH resource and the second PUCCH resource;
identification of at least one PUCCH resource of the first PUCCH resource or the second PUCCH resource that does not overlap with any PUSCH resource of the one or more PUSCH resources in which the CORESET pool value associated with at least one PUSCH resource of the one or more PUSCH resources is equal to a corresponding CORESET pool value associated with the at least one PUCCH resource; or
identification of the at least one PUCCH resource of the first PUCCH resource or the second PUCCH resource that overlaps with the at least one PUSCH resource in which the CORESET pool value associated with the at least one PUSCH resource is different than the corresponding CORESET pool value associated with the at least one PUCCH resource.

15. The method of claim 1, further including:
refraining, by the UE, from transmission of the first PUCCH resource and the second PUCCH resource in response to the transmitting the one or more PUSCH resources.

16. A user equipment (UE) configured for wireless communication,
comprising:
at least one processor; and
a memory coupled to the at least one processor,
wherein the at least one processor is configured:
to determining, by the UE, that a first physical uplink control channel (PUCCH) resource including one or more first uplink control information (UCI) messages associated with a first control resource set (CORESET) pool index value overlaps in a time domain with a second PUCCH resource including one or more second UCI messages associated with a second CORESET pool index value;
to identify, by the UE, one or more physical uplink shared channel (PUSCH) resources that overlaps in the time domain with at least one of the first PUCCH resource or the second PUCCH resource;
to multiplex, by the UE, one or more of the one or more first UCI messages and the one or more second UCI messages onto one or more of the one or more PUSCH resources; and
to transmit, by the UE, the one or more PUSCH resources on an associated component carrier after executing the configuration to multiplex.

17. The UE of claim 16, wherein the associated component carrier is one of: a same component carrier or a different component carrier as a PUCCH component carrier on which the first PUCCH resource and the second PUCCH resource may be simultaneously transmitted.

18. The UE of claim 16, wherein the configuration of the at least one processor to identify the one or more PUSCH resources includes configuration of the at least one processor to identify a first PUSCH resource of the one or more PUSCH resources that overlaps with both of the first PUCCH resource and the second PUCCH resource, wherein the configuration of the at least one processor to multiplex includes configuration of the at least one processor to multiplex the one or more first UCI messages and the one or more second UCI messages onto the first PUSCH resource.

19. The UE of claim 16,
wherein the configuration of the at least one processor to identify the one or more PUSCH resources includes configuration of the at least one processor:
to identify a first PUSCH resource of the one or more PUSCH resources that overlaps with the first PUCCH resource, wherein the one or more first UCI messages are multiplexed onto the first PUSCH resource; and
to identify a second PUSCH resource of the one or more PUSCH resources that overlaps with the second PUCCH resource, wherein the one or more second UCI messages are multiplexed onto the second PUSCH resource,
wherein the configuration of the at least one processor to transmit includes configuration of the at least one processor to transmit the first PUSCH resource and the second PUSCH resource.

20. The UE of claim 19, wherein the configuration of the at least one processor to identify the first PUSCH resource and the second PUSCH resource is in response to the UE determining that a single PUSCH resource of the one or more PUSCH resources fails to overlap both of the first PUCCH resource and the second PUCCH resource.

21. The UE of claim 19, wherein the first PUCCH resource is scheduled earlier in the time domain than the second PUCCH resource.

22. The UE of claim 19, wherein, when the first PUCCH resource has a same starting time as the second PUCCH resource, the UE identifies the first PUSCH that overlaps the first PUCCH resource having the one or more first UCI messages associated with the first CORESET pool index value that is one of a higher value or a lower value than the second CORESET pool index value associated with the one or more second UCI messages of the second PUCCH resource.

23. The UE of claim 19, wherein the first PUSCH resource and the second PUSCH resource are a same PUSCH resource.

24. The UE of claim 16, wherein the configuration of the at least one processor to identify the one or more PUSCH resources includes configuration of the at least one processor:
to identify a first PUSCH resource of the one or more PUSCH resources that overlaps with the first PUCCH resource, wherein the one or more first UCI messages are multiplexed onto the first PUSCH resource;
to determine whether any remaining PUSCH resource of the one or more PUSCH resources excluding the first PUSCH resource overlaps the second PUCCH resources,
wherein, in response to at least one PUSCH resource overlapping with the second PUCCH resource, the one or more second UCI messages are multiplexed onto a second PUSCH resource of the at least one PUSCH resource, and
wherein, in response none of the one or more PUSCH resources excluding the first PUSCH resource overlaps with the second PUCCH resource, one of:
the one or more second UCI messages are multiplexed onto the first PUSCH resource when the first PUSCH resource also overlaps with the second PUCCH resource; or
an error state is declared by the UE, wherein the UE refrains from execution of the configuration of the at least one processor to multiplex and to transmit the one or more PUSCH resources.

25. The UE of claim 24, wherein the first PUCCH resource is identified for being earlier in the time domain than the second PUCCH resource.

26. The UE of claim 16, further including configuration of the at least one processor:
to multiplex, by the UE, the one or more first UCI messages and the one or more second UCI messages onto a multiplexed PUCCH resource;
to determine, by the UE, whether any PUSCH resource of the one or more PUSCH resources overlaps with the multiplexed PUCCH resource,
wherein, in response to at least one PUSCH resource of the one or more PUSCH resources overlapping with the multiplexed PUCCH resource, the one or more first UCI messages and the one or more second UCI messages are multiplexed onto a first PUSCH resource of the at least one PUSCH resource, and
wherein, in response to none of the one or more PUSCH resources overlapping with the multiplexed PUCCH resource, execute a configuration of the at least one processor to transmit, by the UE, the multiplexed PUCCH resource and the one or more PUSCH resources.

27. The UE of claim 26, wherein the configuration of the at least one processor to multiplex the one or more first UCI messages and the one or more second UCI messages onto the multiplexed PUCCH resource, and the configuration of the at least one processor to determine whether the PUSCH resource overlaps with the multiplexed PUCCH resource is performed in response to:
identification of at least one PUCCH resource of the first PUCCH resource or the second PUCCH resource that overlaps with at least one PUSCH resource of the one or more PUSCH resources in which the CORESET pool index value associated with the at least one PUSCH resource is different than a corresponding CORESET pool index value associated with the at least one PUCCH resource; and
identification of the at least one PUCCH resource of the first PUCCH resource or the second PUCCH resource that does not overlap with any PUSCH resource of the one or more PUSCH resources in which the CORESET pool index value associated with the any PUSCH resource is equal to the corresponding CORESET pool index value associated with the at least one PUCCH resource.

28. The UE of claim 16, further including configuration of the at least one processor to receive, by the UE, a radio resource control (RRC) message including a PUSCH multiplexing parameter that identifies a predetermined procedure for the identifying the one or more PUSCH resources that overlaps in the time domain with the at least one of the first PUCCH resource or the second PUCCH resource.

29. The UE of claim 16, wherein the configuration of the at least one processor to multiplex the one or more of the one or more first UCI messages and the one or more second UCI messages onto the one or more of the one or more PUSCH resources includes one or more of:
identification of the one or more PUSCH resources irrespective of a CORESET pool value associated with the one or more PUSCH resources that overlap with one or both of the first PUCCH resource and the second PUCCH resource;
identification of at least one PUCCH resource of the first PUCCH resource or the second PUCCH resource that does not overlap with any PUSCH resource of the one or more PUSCH resources in which the CORESET pool value associated with at least one PUSCH resource is equal to a corresponding CORESET pool value associated with the at least one PUCCH resource; or
identification of the at least one PUCCH resource of the first PUCCH resource or the second PUCCH resource that overlaps with the at least one PUSCH resource in which the CORESET pool value associated with the at least one PUSCH resource is different than the corresponding CORESET pool value associated with the at least one PUCCH resource.

30. The UE of claim 16, further including configuration of the at least one processor to refrain, by the UE, from transmission of the first PUCCH resource and the second PUCCH resource in response to the execution of the configuration of the at least one processor to transmit the one or more PUSCH resources.
